(19) United States
(12) Patent Application Publication
(10) Pub. No.: US 2016/0232560 A1
(43) Pub. Date: Aug. 11, 2016

(54) SYSTEMS AND METHODS FOR A BAR CODE MARKET EXCHANGE FOR COUPONS

(71) Applicant: 12 DIGIT MEDIA INC., Menlo Park, CA (US)

(72) Inventor: Scott Raymond VanDeVelde, Menlo Park, CA (US)

(73) Assignee: 12 DIGIT MEDIA INC., Menlo Park, CA (US)

(21) Appl. No.: 15/013,757

(22) Filed: Feb. 2, 2016

Related U.S. Application Data
(60) Provisional application No. 62/111,066, filed on Feb. 2, 2015.

(51) Int. Cl. G06Q 30/02

(52) U.S. Cl. CPC G06Q 30/0239; G06Q 30/0238

(57) ABSTRACT

Campaigns for providing coupons to a consumer can include collecting shopping cart data from POS terminals in physical stores, the shopping cart data identifying a consumer using a unique consumer identification and identifying one or more UPCs scanned while the identified consumer is present at a POS terminal, and conducting an online UPC auction to collect bids, by UPC(s), for delivery of coupons to the identified consumer triggered by scanning of a UPC/UPCs, in which winning bids, if any, are determined as of the time the identified consumer is present at the POS terminal. Further, the campaign can include, on behalf of a winning bidder, fulfilling the winning bidder's bid by, at least one of, sending the coupon to the POS terminal for printing, sending a message to the POS terminal for printing, and sending an electronic coupon to the consumer.

### RELATED APPLICATIONS

This application claims the benefit of U.S. Provisional Patent Application No. 62/111,066 filed on Feb. 2, 2015, which is hereby incorporated by reference.

### BACKGROUND

1. Technological Field

The present technology relates to systems and methods for providing targeted coupons to an identified consumer. Specifically, the present technology relates to systems and methods for targeting consumer interests in a product and delivering targeted coupons based on the consumer's interest in the product and based on received bids from one or more entities for providing the targeted coupons to the identified consumer.

2. Description of Related Art

Coupons, which are vouchers entitling the holder to a discount for a particular product, have been used as marketing tools since Coca Cola issued the first coupon in 1887. Since then, paper coupons have grown into a $4 billion market in the U.S. alone, with a current redemption rate of approximately 3 billion coupons a year. However, the high point for paper coupons was in 1992, when 7.9 billion discounts were redeemed. Market research indicates that consumer expectations are moving away from paper coupons toward coupons in electronic format.

In 1973, after 4 years of preparation, IBM presented a proposal to the Super Market Committee in Rochester, Minn. for a bar code format and associated scanner to improve supply chain management. The goal was to develop a system that would uniquely identify each product from each manufacturer. The system was called a Universal Product Code (UPC), and it was accepted by the Super Market Committee. This decision ultimately led to the creation of the international standards organization called GS1, formerly known as the Uniform Code Council, which now assists 110 member countries with supply chain standards. The UPC code defined 10 different numbering systems, where 5 of the 10 numbering systems were for most products, 1 of the 10 numbering systems was for local use for products sold by weight, 1 of the 10 numbering systems was for drugs based on the National Drug Code, 1 of the 10 numbering systems was for local use for loyalty cards or store coupons, and 2 of the 10 numbering systems were for manufacturer coupons. The UPC is considered a foundational, one dimensional coding system, with extensions such as UPN (i.e., universal product numbers, typically for providing codes for identifying pharmaceutical products, medical devices, etc.), UPC-E, which is a variation of the standard UPC that excludes any zeros, EAN (i.e., a European article number), ISBN (i.e., an international standard book number), and so on. Throughout this document, the term UPC is generally used and may include additional codes, such as those mentioned above or those mentioned below.

Additional two dimensional coding systems such as PDF417, GS1 Databar, DataMatrix, and QR Code can store much more data in a smaller area, and are useful additions to the UPC method. In this application, reference to a UPC code is, in the interest of brevity, inclusive of all point of sale product coding systems, and does not limit in any way the coding systems available to the technology disclosed.

A manufacturer of a product can use coupons in a number of ways. A low value coupon can be for, say, offering a dollar amount representing 10% off the purchase price. A high value coupon can be for, say 50% off the purchase price. The manufacturer can direct coupons toward their current consumers (e.g., customers) in order to increase sales of a particular item. Or, the manufacturer can distribute coupons with a goal to convert the competitor's customer into the manufacturer's customer.

In the related art, various features of U.S. Patent Application Publication No. 2014/0207556 are illustrated in FIGS. 1A and 1B of the present application. Specifically, FIGS. 1A and 1B illustrate components of a Point of Sale (POS) system and processing methods thereof. Although FIGS. 1A and 1B describe the identification of an offer in reference element 720, this identification of the offer is tedious, not user friendly and does not provide a user interface for manufacturer involvement, which is addressed by the technology disclosed. Further, although FIG. 1A describes the redemption of an offer in reference element 670, this related art provides no indication as to when or how coupons are issued, which is addressed by the technology disclosed.

Furthermore, in the related art, various features of U.S. Patent Application Publication No. 2014/0278858 are illustrated in FIGS. 2A, 2B, and 2C of the present application. FIGS. 2A and 2C illustrate an implementation of an ad placement program 75, where coupons are communicated from a manufacturer computer 80 to a master coupon database 77. Further, FIGS. 2A-2C illustrate that a user is invited to a scan a UPC 14 of a manufacturers product 12 (e.g., a Cheerios® box) to find available coupons in the master coupon database 77. This process is also tedious and requires much user interaction with little manufacturer control. These shortcomings are addressed by the technology disclosed.

Additionally, in the related art, various features of U.S. Patent Application Publication No. 2012/0310722 are illustrated in FIG. 3 of the present application. FIG. 3 illustrates a consumer 15 interaction with a kiosk 16 that is coupled to a store POS 27, leading to clearing and electronic settlement with a retailer who honors the offer. However, this related art also requires significant retailer and consumer interaction with little manufacturer control. These shortcomings are address by the technology disclosed.

Also, in the related art, various features of U.S. Patent Application Publication No. 2014/0278906 are illustrated in FIGS. 4A and 4B of the present application. FIGS. 4A and 4B illustrate an implementation of an ad placement program 75, where coupons are communicated from a manufacturer computer 80 to a master coupon database 77. This process is also tedious and requires much user interaction with little manufacturer control. These shortcomings are addressed by the technology disclosed.

Moreover, in the related art, various features of U.S. Pat. No. 6,269,361 are illustrated in FIG. 5 of the present application. FIG. 5 illustrates an implementation of a bidding system for online advertisement as a result of a user search. However, this system does not provide coupons to a user based on a manufacturer's bids, which is provided by the technology disclosed.

Chinook Book®, which is also related art (not illustrated), is a coupon book application which requires significant user interaction requiring the consumer to search and locate specific coupons and requires a paid subscription for some of the coupons. The application vendor makes money by charging retailers to populate the application with coupons and by charting the consumer to have access to all of the coupons. These shortcomings are addressed by the technology disclosed.

### General Shortcomings of the Related Art

The use of coupons not only help a manufacturer promote their own product, but can be a marketing tool used to target specific competitors. In one example, the Cheerios® brand from General Mills® ideally might want to provide a 24 oz. (trade up larger size) coupon for $2.00 to their consumers who recently purchased a 16 oz. Cheerios® brand. And Kellogg's®, a competitor, might ideally want to distribute a coupon for $3.00 off on their 16 oz. box of Corn Flakes®. But without having the knowledge and ability to identify and distribute highly personalized and targeted coupons a common method is for each of the manufacturers to have a large number of “generic” coupons printed and distributed. An average price for these coupons can be $4.50 per 1,000 coupons, which is often referred to as a cost per mille (CPM). The most common method of distributing these coupons is through free standing inserts (FSI's). FSI containing 287 billion coupons were distributed in 2013, which is 91% of all coupons created in the U.S. that year. For the most part, these coupons are part of mass marketed and non-targeted promotional campaigns that take months to execute. These non-targeted promotional campaigns are often wasteful in terms of expense, effort and time.

Generally, manufacturers do not have access to retailer's data regarding transactions with consumers. Without direct access to the retailer's data, it is difficult for manufacturers to promote, and distribute personalized and relevant coupons to consumers with scale based on their purchase habits on products and categories they buy. As a result manufacturers just target coupons to demographic segments and put out bulk amounts of untargeted coupons via FSIs. Retailers have thin margins and need relief from the onerous challenges that arise when manufacturers distribute tens of millions of bulk FSI coupons. These challenges include having to build up inventory on the promoted items, having to handle millions of paper coupons, having to fund the coupon value for 30+ days and potentially losing money due to fraud, lost redemption and/r improper redemption.

These general shortcomings of the related art are address by the technology disclosed.

### Specific Manufacturer Challenges and Solutions Provided by the Technology Disclosed

Despite all the technical and digital advancements over the past 20 years, manufacturers continue to use the outdated asynchronous method of trying to engage with consumers. As a result there continues to be a proliferation of generic paper coupons that add little value to retailers, consumers and manufacturers. The issues for manufacturers include: (i) reach; (ii) volume; (iii) efficiency; (iv) thin margins; (v) implementation of trial versus subsidization; (vi) lead time; (vii) lack of real time data and analysis; and (viii) difficulty in targeting a long tail of consumer product interest.

Regarding the reach of manufacturers, FSI is technically cumbersome, but well established as the only means of reaching a large enough audience on a single data with a coupon resulting in scaled redemptions/product sales. For example, approximately 90% of all coupons are distributed as FSIs, but approximately only 41% of all coupons redeemed are from FSIs (2014 Inmar Coupon Trends Report, http://go.inmar.com/rs/inmar/images/Inmar_2014_Coupon_Trends_Report.pdf).

Regarding the manufacturers volume of coupon distribution, other forms of digital coupon distribution (e.g., Coupons.com®, Cellfire®, etc.) have not achieved a network effect. Mobile applications and online websites lack the scale of users to generate significant sales for manufacturers. Digital coupons represent approximatelyl % of coupons distributed and redeemed by consumers (2014 Inmar Coupon Trends Report, http://go.inmar.com/rs/inmar/images/Inmar_2014_Coupon_Trends_Report.pdf).

Regarding manufacturer's efficiency in distribution of coupons, the current methods are cumbersome and include the untargeted distribution of coupons of lead consumer packaged goods (GPC) manufacturers, which results in paying a high cost for targeting coupons to the right consumer based on purchase data via, for example, Catalina Marketing's print and point of sale (POS) system at approximately $100+CPM with, for example, an average of approximately 6% redemption, or paying $4.50 CPM for a mass coupon “drop” via an FSI in the Sunday newspaper at less than or equal to approximately 0.5% redemption (2014 Inmar Coupon Trends Report, http://go.inmar.com/rs/inmar/images/Inmar_2014 Coupon_Trends_Report.pdf and 2014 Kantar Media FSI Trends Report, http://www.tnsmi-marx.com/KantarMediaFSlTrends_2014.pdf). In both cases they are paying a fixed fee for distribution resulting in a high cost per coupon redeemed cost.

Regarding the manufacturer's thin margins, for many CPG manufacturers, long lead times and lack of targeting makes it very difficult to justify the cost to distribute and pay for clearing of a coupon (e.g., packaging and sending coupons to a coupon clearinghouse for counting and eventually redemption to a retailer) based on very low profit margins on their products. With fixed pricing for distribution and coupon clearing for paper coupons, it is a money losing proposition to frequently deliver coupons to consumers via traditional means, especially to loyal consumers.

Regarding the dilemma of manufacturer's providing product trials versus subsidization, manufacturers have the challenge of choosing the right coupon that will appeal to the greatest number of consumers. Long lead times make coupon testing impractical. Manufacturers are trying to get new people to try their product, which requires a higher value coupon without subsidizing their existing consumers who might have bought the product without a coupon or incentive. FSI coupons are distributed to all consumers without targeting based on these factors.

Regarding manufacturer's difficulty with coupon lead times, FSI coupons require months of planning related to creative, versioning, printing, shipment to newspapers and delivery.

Regarding manufacturer's lack of real time data and analysis, due to long lead prior to delivery and a very long process for redeeming paper coupons, manufacturers are unable to quickly measure return on investment (ROI) and apply many of the real-time test and learn methodologies that are afforded by many internet models (e.g., search engine marketing such as Google Adwords).

Regarding manufacturer's difficulty in targeting consumer's interests, there are over 35,000 products sold in grocery stores, and manufacturers have little visibility into the purchasing behavior of individual consumers (“Guess How Many Items the Average Grocery Shopper Buys in a Year?” Jan. 23, 2013, http://couponsinthenews.com/2014/01/23/guess-how-many-items-the-average-grocery-shopper-buys-in-a-year/). As such they target their coupon buys at “demographic segments” versus having the ability to target specifically at the individual consumer level.

The technology disclosed responds to these technical challenges by providing some or all of the following advantages over current coupon distribution methods. For example, the technology disclosed may provide coupon distribution methods that are targeted at the UPC level (e.g., a UPC granular level), that provide for easy to redeem, that provide optimization algorithms based on a target redemption rate, that provide dashboards for analysis and that provide AB (e.g., split) and multivariate testing (e.g., auditioning) of coupon to measure redemption and conversion.

Additional Manufacturer, Retailer and Consumer Challenges and Solutions Provided by the Technology Disclosed

In the traditional manufacturer/retailer/coupon environment, there is a contemplation of “scarcity” meaning that there will be a limited number of coupons distributed to consumers by category so only the top winning manufacturer bids will get fulfilled, and that there will be a limited number of coupon impressions (e.g., coupons that can be delivered) available per consumer at any given point in time. Further, in the traditional environment, there is also contemplation of “guaranteed distribution” by a manufacturer willing to pay a premium and for pre-book impression distribution before the bidding process begins. In this traditional environment, there are challenges involving each of manufacturer, retailer and consumer. Many of these challenges and potential solutions thereto by the technology disclosed are discussed below.

One challenge is that paper coupons are subject to fraud. The technology disclosed is capable of overcoming these challenges by providing fraud detection algorithms and data security through encrypted communications.

Another challenge is that current coupon distribution methods are only cost effective for the largest manufacturers, such that the current distribution methods are not viable for smaller manufacturers. The technology disclosed is capable of overcoming these challenges by providing performance based bidding options for the manufacturers and providing an aggregation of niche audiences through granular UPC data.

Another challenge is that current coupon targeting solutions lock out certain manufacturers because coupons are sold on a category exclusive basis, causing many opportunities for coupon distribution to be lost (e.g., there are many lost opportunities in a coupon market directed to remnant UPCs which are essentially left over UPCs that have not be exclusively sold through a pre-auction channel, there are many lost opportunities on a granular UPC level for UPCs that are not targeted for coupons, etc.). The technology disclosed is capable of overcoming this challenge by providing an open, real-time marketplace available to all UPCs and/or available to the remnant UPCs that have not been exclusively sold through a pre-auction channel.

Another challenge is that there are hundreds of thousands of UPCs making it cumbersome to create a campaign for each individual UPC target. The technology disclosed is capable of overcoming these challenges by providing a searchable database for the manufacturers to target coupons, by providing campaign wizards and templates to the manufacturers, by providing a programmatic interface, such as customizable bidding interfaces and customizable campaign results interfaces, and by providing for the automatic addition of new UPCs to the database.

Another challenge is that the cost of effectively targeting a long tail of consumer UPC/product interest and delivering a hyper-targeted coupon to a large targeted consumer population on a timely basis relative to their interests. The technology disclosed is capable of overcoming these challenges by allowing manufacturers to view hundreds of thousands of products in a searchable database, each identified by their unique UPC, that are being purchased by their customers and/or competitors customers, by allowing manufactures to cherry pick and select only a collection of UPCs that represent their target audience (e.g., consumers who buy their own product UPCs or the buyers of competitive products) and competitively bid for the ability to have their specific product coupon delivered to this audience, by allowing manufacturers that are in low penetration categories (e.g., baby food at 15% population) to avoid spending impressions/budget against the remaining 85% of the population who doesn't buy this category and instead put that budget against higher value coupons for the 15% category buyers, by providing feedback to the manufacturer if the manufacturer's bids are too low, such as for example, providing suggested bids, reminders and estimated inventory, and by providing the manufacturers with a wizard that enables suggested campaigns (e.g., groups of UPCs to target, number of impressions per user, etc.) based on inputs such as campaign objectives, budgets and metrics for success.

### Additional Retailer Challenges and Solutions Provided by the Technology Disclosed

While retailers have millions of consumers who walk through their aisles each week they do not use technology to either improve the consumer experience in their stores or to monetize this traffic in ways other than the small margins made on grocery items. Additionally they are at the mercy of manufacturer programs that haven't changed much in 20 years. As a result they face the following challenges: (i) low margins; (ii) little monetization of store traffic; (iii) paper coupon fraud; and (iv) a cumbersome reimbursement process.

Regarding the challenge of low margins for the retailers, retailers make very little money selling groceries and much of the money they do make comes from trade dollars or market development funds (MDF) paid for by manufacturers which has nothing to do with the actual selling of products but instead is money paid to the retailer to shelve and feature certain products at certain locations throughout the year (e.g., slotting fees, end cap displays, features in store circular, loyalty programs, etc.).

Regarding the challenge of little monetization of store traffic, retailers attract millions of consumers into their stores each week with the average consumer going into a grocery store more than twice a week (“U.S. Grocery Shopper Trends 2012 Executive Summary,” http://www.icn-net.com/docs/12086_FMIN_Trends2012_v5.pdf). FSI coupons drive people into these stores but the retailer does not get paid any part of the media dollars paid by manufacturers to put the coupons in the hands of their customers, yet the retailers bear all of the burden of collecting, scanning, and sending paper coupons to clearing houses and carrying the float for redemptions prior to manufacturer reimbursement.

Regarding the challenge of paper coupon fraud, a well-documented problem for manufacturers and retailers in coupon fraud is related to FSI coupons (“Coupon Fraud Ticking Up in 2012” September, 2012; https://www.inmar.com/newsletters/Pages/Coupon-Fraud-Ticking-Up-in-2012.aspx?Edition=20&Category=promotions). Hundreds of millions of dollars a year are lost as a result of people mass clipping and creating false redemptions that do not result in a sale but cost the manufacturer and retailer.

Regarding the cumbersome reimbursement process, paper coupons are sorted and routed to clearing houses that tally the reimbursement for each retailer, and then transfer payment weeks after the purchase. This opens up issues of fraud, slippage of payment and long float times for retailers to get paid.

These above-described problems can be solved using the technology disclosed which provides a programmatic marketplace, where the retailer can achieve better monetization of regional consumer purchase data, where the retailer can utilize a self-service marketplace individually or within a group of retailers to achieve a national footprint (e.g., through an establishment of a consortium of retailers) for vendors to target with national marketing dollars, and where the retailer and vendor can develop a more cost effective way to work with the long tail of vendors (e.g., of 10,000 plus brand manufacturers as they develop merchandising plans together). Realistically it is not feasible to spend a lot of time with each manufacturer to create promotional coupon campaigns on a regular basis, but this problem is solved by the technology disclosed which can provide a self-service marketplace where vendors can routinely log in and create their own campaigns in minutes.

### Additional Consumer Challenges and Solutions Provided by the Technology Disclosed

Consumers have embraced all the internet platforms and services that have profoundly improved their lives and personalized their shopping experience online and that have saved them time and/or money. Unfortunately these advances haven't progressed to the grocery store making consumers feel that they are not benefiting from the new technology provided on, for example, the internet platform, and making consumers feel that there is no level of personalized and/or customized coupons.

For example, consumers face the following challenges: (i) lack of scale/availability of high value coupons (e.g., 61% of consumers say they can't find coupons for the products they want to buy, “Coupons Still Key for Consumers” by Brad Hanna; Jun. 9, 2014; http://www.cpgtrends.com/2014/06/coupons-still-key-for-consumers); (ii) the modality of a paper coupon (e.g., cutting, saving, carrying, redeeming); and (iii) receiving marketing/coupons that are mass targeted and are not relevant for each consumer and/or the coupon value isn't large enough to be meaningful to the consumer.

The technology disclosed solves these consumer problems by providing a marketplace (e.g., an online exchange, an online auction, etc.) for implementing campaigns using relevance algorithms based on, for example: (i) bid rate/amount (e.g., highest bid for delivery of a coupon); (ii) (bid×historical or projected redemption rate); (iii) (bid rate/amount×redemption rate)×(dollar coupon value/# of items required for redemption); (iv) (bid rate/amount×redemption rate)×(% discount off average retail price); (v) propensity to purchase a particular UPC at the consumer level; and (vi) beacon prompting so when a consumer is in a given section/aisle they are prompted with the higher value coupon appropriate for them.

Another challenge for the consumer is that many of the brands consumers shop for don't have coupons available. Coupons are typically limited to large, national brands, not smaller or more regional brands, leaving, for example, a large amount of remnant UPCs and/or non-remnant UPCs that could be targeted for a coupon campaign. To address these challenges the technology disclosed can provide an open, real-time marketplace and provide an aggregation of coupons to niche audiences through granular level and/or group level UPC data.

Another challenge for the consumer is that finding, keeping track of, and redeeming coupons is a cumbersome process causing the vast majority of consumers to ignore them. To address these challenges, the technology disclosed can provide a user application (e.g., a mobile device application) that displays relevant, timely coupons, that automatically removes expired coupons and alerts when they are about to expire or have expired, and that provides for automatic coupon redemption or single scan redemption.

As mentioned above, a challenge for the consumer is that they are not able to get high value coupons delivered to them automatically without having to clip, carry and redeem them. This challenge for the consumer is addressed by the technology disclosed, which can provide a programmatic marketplace in which collaborative filtering can be used to learn redemption rates of the coupons delivered to a similar target audience to drive the selection of the highest value coupon to ensure consumer relevancy, and can provide marketplace intelligence that powers a consumer (e.g., mobile device) application to deliver a large quantity of high value digital coupons that are categorized and sorted based on the consumers' demonstrated historical redemptions and usage.

Additional benefits of the technology disclosed are that it will be possible to: (i) achieve true customization at the user level, such that, for example, even with tens of millions of consumers, two consumers will most likely not get the same portfolio of coupons; (ii) maintain a better understanding on how to optimize an order of coupons presented to the consumer, such as in an application running on a portable consumer device, by placing most valuable coupons in a prominent position for each consumer based on the consumer's propensity to redeem that coupon/category of coupons; (iii) provide the consumer with the ability to search/rank coupons based on numerous filter criteria (e.g., monetary value, % discount, expiration date, product category, etc.); (iv) provide the consumer with the ability to rank/remove each coupon (e.g. keep each coupon in the application running on the portable consumer device, remove each coupon as it is redeemed and/or, remove each coupon and never show it again, even if the coupon has not been redeemed); (v) provide the consumer with the ability to create and print shopping lists while easily incorporating items for which coupons are available into the shopping list; (vi) automatically remove coupons upon expiration; (vii) provide the manufacturer the ability to modify expiration dates of coupons based on new winning bids; (viii) easily deliver coupons to the consumer directly (e.g., in a printed version at the time of purchase at a POS terminal) or via the application running on the consumer's portable device at or around (e.g., within a few hours; within 24 hours, etc.) the time of purchase based on UPCs (e.g., the intent would be that the coupons are delivered to the consumer prior to their next visit to the retailer); (ix) control a frequency of providing coupons at the user level based on manufacturers' and retailers' unique knowledge of consumer purchasing habits and providing an ability to identify consumers based on their application running on the consumer's portable device; and (x) provide numerous ways for the application running on the consumer's portable device to interface with communication points (e.g., store beacons) within the retailer's facility for providing intelligent consumer alerts.

In summary, the state of the related art is such that a bulk of coupons are designed to provide a discount for a particular UPC for a campaign that is not targeted at a UPC granular level and with a duration of, usually, months at a time, where each part of the coupon distribution and reimbursement process requires a substantial time frame, and where FSI coupons typically require nine to twelve weeks for art and distribution. The technology disclosed allows the procurement and distribution of coupons in near real time targeted at a UPC granular level as briefly discussed above and as described in detail below.

### SUMMARY OF THE INVENTION

Aspects of the present disclosure are to address at least the above-mentioned problems and/or disadvantages and to provide at least the advantages discussed above and further described below. Accordingly, an aspect of the present disclosure is to provide a computer-implemented method and a system for targeting consumer interest in a product and delivering targeted coupons based on the consumer's interests in the product.

In accordance with an aspect of the present disclosure a computer-implemented method of providing one or more targeted coupons to a consumer is provided. The computer-implemented method includes collecting shopping cart data from numerous point of sale (POS) terminals in physical stores, the shopping cart data identifying a consumer using a unique consumer identification and identifying one or more universal product codes (UPCs) scanned while the identified consumer is present at one of the POS terminals, and conducting an online UPC auction to collect bids, by UPC or a group of UPCs, for delivery of coupons to the identified consumer triggered by scanning of a UPC or UPCs in the physical stores, in which winning bids, if any, are determined as of the time the identified consumer is present at the POS terminal

In this computer-implemented method a current winning bidder for a particular UPC is entitled to send their coupon to the POS terminal for printing, to send a message to the POS terminal for printing that refers to an electronic coupon delivery, and/or send an electronic coupon to the identified consumer, and the online UPC auction accepts bids and withdrawal of bids from bidding participants using bidding terminals, and determines the current winning bidder from among the bidding participants on an ongoing basis by (i) providing a bidding interface to the bidding terminals that identifies the UPCs that are available through the online UPC auction, (ii) receiving from the bidding interface, bids on selected UPCs of the available UPCs, (iii) tracking, for the selected UPCs, bid scores based at least in part on the bids on the selected UPCs, and (iv) while the identified consumer remains present at the POS terminal, using at least the bid scores to determine a current best bid for a particular UPC and determining, among the one or more UPCs identified by the shopping cart data, which UPCs have winning bidders.

Finally, this computer-implemented method includes, on behalf of a winning bidder, fulfilling the winning bidder's bid by, at least one of, sending the coupon to the POS terminal for printing, sending the message to the POS terminal for printing, and sending the electronic coupon to the identified consumer

In accordance with another aspect of the present disclosure a computer-implemented method of providing one or more targeted coupons to a consumer is provided. This computer-implemented method includes collecting one or more UPCs scanned while a consumer is present at one POS terminal of numerous POS terminals in physical stores, and conducting an online UPC auction to collect bids, by UPC or a group of UPCs, for delivery of coupons to the consumer triggered by scanning of a UPC or UPCs in the physical stores, in which winning bids, if any, are determined as of the time the consumer is present at the POS terminal.

In this computer-implemented method a current winning bidder for a particular UPC is entitled to send their coupon to the POS terminal for printing, and the online UPC auction accepts bids and withdrawal of bids from bidding participants using bidding terminals, and determines the current winning bidder from among the bidding participants on an ongoing basis by (i) providing a bidding interface to the bidding terminals that identifies the UPCs that are available through the online UPC auction, (ii) receiving from the bidding interface, bids on selected UPCs of the available UPCs, (iii) tracking, for the selected UPCs, bid scores based at least in part on the bids on the selected UPCs, and (iv) while the consumer remains present at the POS terminal, using at least the bid scores to determine a current best bid for a particular UPC and determining, among the one or more collected UPCs, which UPCs have winning bidders.

Finally, this computer-implemented method includes, on behalf of a winning bidder, fulfilling the winning bidder's bid by sending the coupon to the POS terminal for printing.

In accordance with another aspect of the present disclosure a computer-implemented method of providing one or more targeted coupons to a consumer is provided. This computer-implemented method includes accumulating, as historical data, shopping cart data from numerous POS terminals in physical stores, the shopping cart data identifying a consumer using a unique consumer identification and identifying one or more UPCs scanned while the identified consumer is present at one of the POS terminals, and conducting an online UPC auction to collect bids, by UPC or a group of UPCs, for delivery of coupons to the identified consumer triggered by identification of the consumer at the POS terminal, in combination with the historical data that identifies UPCs of goods purchased by the identified consumer in the physical stores, in which winning bids, if any, are determined as of the time the identified consumer is present at the POS terminal.

In this computer-implemented method the online UPC auction is conducted using the one or more UPCs identified by the historical data collected in a historical period of at least one week and associated with the unique consumer identification of the identified consumer, a current winning bidder for a particular UPC is entitled to send their coupon to the POS terminal for printing, to send a message to the POS terminal for printing that refers to an electronic coupon delivery, and/or send an electronic coupon to the identified consumer, and the online UPC auction accepts bids and withdrawal of bids from bidding participants using bidding terminals, and determines the current winning bidder from among the bidding participants on an ongoing basis by (i) receiving from a bidding interface, bids on selected UPCs of UPCs that are available UPCs through the online UPC auction, the selected UPCs being included in the historical data, (ii) tracking, for the selected UPCs, bid scores based at least in part on the bids on the selected UPCs, and (iii) while the identified consumer remains present at the POS terminal, using at least the bid scores to determine a current best bid for a particular UPC and determining, among the one or more UPCs identified by the historical data, which UPCs have winning bidders.

Finally, this computer-implemented method includes, on behalf of a winning bidder, fulfilling the winning bidder's bid by, at least one of, sending the coupon to the POS terminal for printing, sending the message to the POS terminal for printing, and sending the electronic coupon to the identified consumer.

In accordance with another aspect of the present disclosure a computer-implemented method of providing one or more targeted coupons to a consumer is provided. This computer-implemented method includes collecting shopping cart data from numerous POS terminals in physical stores, the shopping cart data identifying a consumer using a unique consumer identification and identifying one or more remnant UPCs scanned while the identified consumer is present at one of the POS terminals, and conducting an online UPC auction to collect bids, by UPC or a group of UPCs, for delivery of coupons to the identified consumer triggered by scanning of a remnant UPC or remnant UPCs in the physical stores, in which winning bids, if any, are determined as of the time the identified consumer is present at the POS terminal.

In this computer-implemented method the remnant UPC or the remnant UPCs are a portion of available UPCs that have not been exclusively sold through a pre-auction channel, a current winning bidder for a particular remnant UPC is entitled to send their coupon to the POS terminal for printing, to send a message to the POS terminal for printing that refers to an electronic coupon delivery, and/or send an electronic coupon to the identified consumer, and the online UPC auction accepts bids and withdrawal of bids from bidding participants using bidding terminals, and determines the current winning bidder from among the bidding participants on an ongoing basis by (i) providing a bidding interface to the bidding terminals that identifies the remnant UPCs that are available through the online UPC auction, (ii) receiving from the bidding interface, bids on selected remnant UPCs of the available remnant UPCs, (iii) tracking, for the selected remnant UPCs, bid scores based at least in part on the bids on the selected remnant UPCs, and (iv) while the identified consumer remains present at the POS terminal, using at least the bid scores to determine a current best bid for a particular remnant UPC and determining, among the one or more remnant UPCs identified by the shopping cart data, which remnant UPCs have winning bidders.

Finally, this computer-implemented method includes, on behalf of a winning bidder, fulfilling the winning bidder's bid by, at least one of, sending the coupon to the POS terminal for printing, sending the message to the POS terminal for printing, and sending the electronic coupon to the identified consumer.

In accordance with another aspect of the present disclosure a system for providing one or more targeted coupons to a consumer is provided. The system includes a bidding server including a processor and memory configured to receive shopping cart data collected from numerous POS terminals in physical stores, the shopping cart data identifying a consumer using a unique consumer identification and identifying one or more universal product codes UPCs scanned while the identified consumer is present at one of the POS terminals, and conduct an online UPC auction to collect bids, by UPC or a group of UPCs, for delivery of coupons to the identified consumer triggered by scanning of a UPC or UPCs in the physical stores, in which winning bids, if any, are determined as of the time the identified consumer is present at the POS terminal, wherein (i) a current winning bidder for a particular UPC is entitled to, via a fulfillment server, send their coupon to the POS terminal for printing, to send a message to the POS terminal for printing that refers to an electronic coupon delivery, and/or send an electronic coupon to the identified consumer, and (ii) the bidding server, by conducting the online UPC auction, accepts bids and withdrawal of bids from bidding participants using bidding terminals, and determines the current winning bidder from among the bidding participants on an ongoing basis by providing a bidding interface to the bidding terminals that identifies the UPCs that are available through the online UPC auction, receiving from the bidding interface, bids on selected UPCs of the available UPCs, tracking, for the selected UPCs, bid scores based at least in part on the bids on the selected UPCs, and while the identified consumer remains present at the POS terminal, using at least the bid scores to determine a current best bid for a particular UPC and determining, among the one or more UPCs identified by the shopping cart data, which UPCs have winning bidders.

Further, this system includes the fulfillment server including a processor and a memory configured to, on behalf of a winning bidder determined by the bidding server, fulfilling the winning bidder's bid by, at least one of, sending the coupon to the POS terminal for printing, sending the message to the POS terminal for printing, and sending the electronic coupon to the identified consumer.

The various above-described operations of the method are not necessarily limited to the order in which they are described. The order listed above is merely for ease of readability and understanding. Accordingly, the order listed above has no bearing on the actual order of operations performed by the method.

Other aspects, advantages, and salient features of the disclosure will become apparent to those skilled in the art from the following detailed description, which, taken in conjunction with the drawings, discloses various embodiments of the present disclosure.

### BRIEF DESCRIPTION OF THE DRAWINGS

FIGS. 1A and 1B illustrate related art based on U.S. Patent Application Publication No. 2014/0207556.

FIGS. 2A, 2B, and 2C illustrate related art based on U.S. Patent Application Publication No. 2014/0278858.

FIG. 3 illustrates related art based on U.S. Patent Application Publication No. 2012/0310722.

FIGS. 4A and 4B illustrate related art based on U.S. Patent Application Publication No. 2014/0278906.

FIG. 5 illustrates related art based on U.S. Pat. No. 6,269,361.

FIG. 6 illustrates an overview of an implementation of an infrastructure servicing a manufacturer, a retailer, and a consumer, according to an embodiment of the present disclosure.

FIG. 7 illustrates one implementation of a process cycle for a consumer, according to an embodiment of the present disclosure.

FIG. 8 illustrates one implementation of UPC targeting process by a manufacturer, according to an embodiment of the present disclosure.

FIG. 9 illustrates one implementation of a coupon redemption process by a retailer, according to an embodiment of the present disclosure.

FIG. 10 illustrates a process of adding discounts to a consumer's account, according to an embodiment of the present disclosure.

FIG. 11 illustrates one implementation of a process for a retailer to scan coupon codes represented by multiple one-dimensional bar codes, according to an embodiment of the present disclosure.

FIG. 12 illustrates one implementation of a process for a retailer to scan a batch of coupon codes represented by a QR code, according to an embodiment of the present disclosure.

FIG. 13 illustrates one implementation of AB test configuration, according to an embodiment of the present disclosure.

FIGS. 14A, 14B, 14C and 14D illustrate various implementations of providing one or more targeted coupons to a consumer, according to various embodiments of the present disclosure.

FIG. 15 illustrates an implementation of a login screen of an online exchange, according to an embodiment of the present disclosure.

FIG. 16 illustrates an implementation of a campaign wizard of an online exchange for selecting a partner and choosing a campaign objective of a specific campaign, according to an embodiment of the present disclosure.

FIG. 17 illustrates an implementation of a campaign wizard of an online exchange for defining an audience of a specific campaign, according to an embodiment of the present disclosure.

FIG. 18 illustrates an implementation of a campaign wizard of an online exchange for defining audience loyalty and selecting a type of coupon to be provided for a specific campaign, according to an embodiment of the present disclosure, according to an embodiment of the present disclosure.

FIG. 19 illustrates an implementation of a campaign wizard of an online exchange for setting a budget and timeframe for a specific campaign, according to an embodiment of the present disclosure.

FIG. 20 illustrates a dashboard of an online exchange that provides real-time analytics for a specific campaign, according to an embodiment of the present disclosure.

FIG. 21 illustrates an interface of an online exchange that provides real-time monitoring and adjustment of a specific campaign, according to an embodiment of the present disclosure.

FIG. 22 illustrates an interface of an online exchange that provides real-time information regarding a lift of sales for a retailer, according to an embodiment of the present disclosure.

FIG. 23 illustrates screenshots of a consumer application implemented on a smart phone, according to an embodiment of the present disclosure.

FIGS. 24A, 24B, 24C and 24D illustrate a data structures, according to various embodiments of the present disclosure.

FIG. 25 illustrates a block diagram of an example computer system, according to an embodiment of the present disclosure.

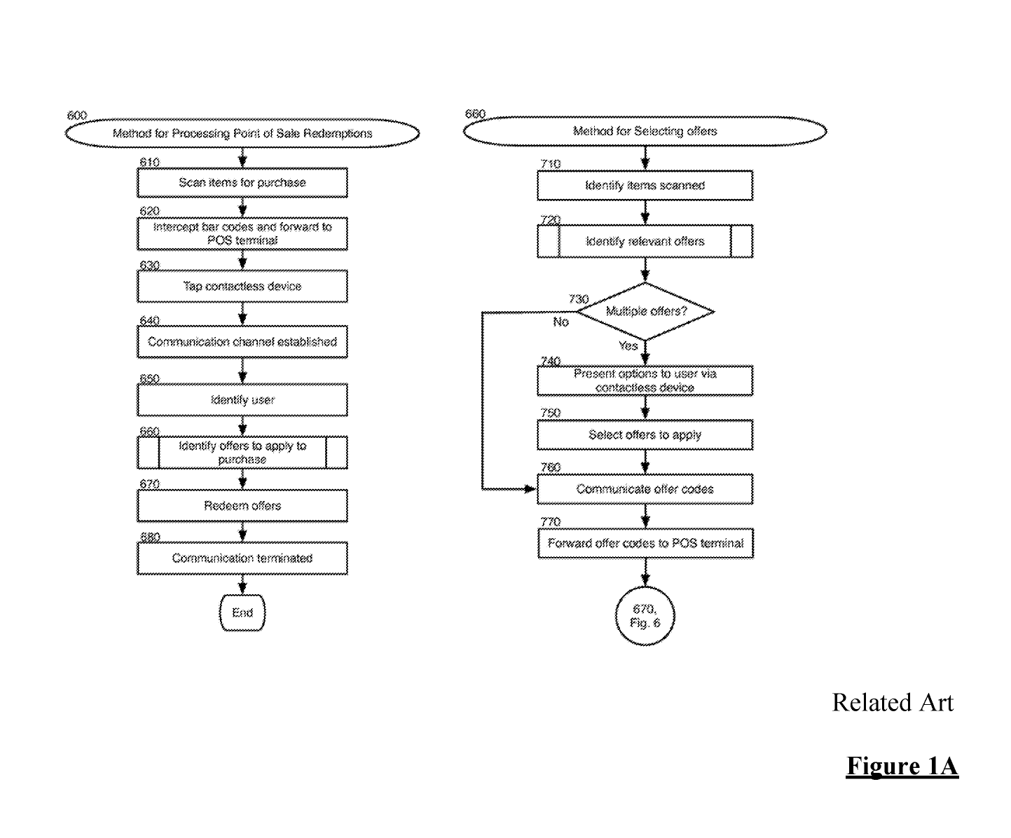

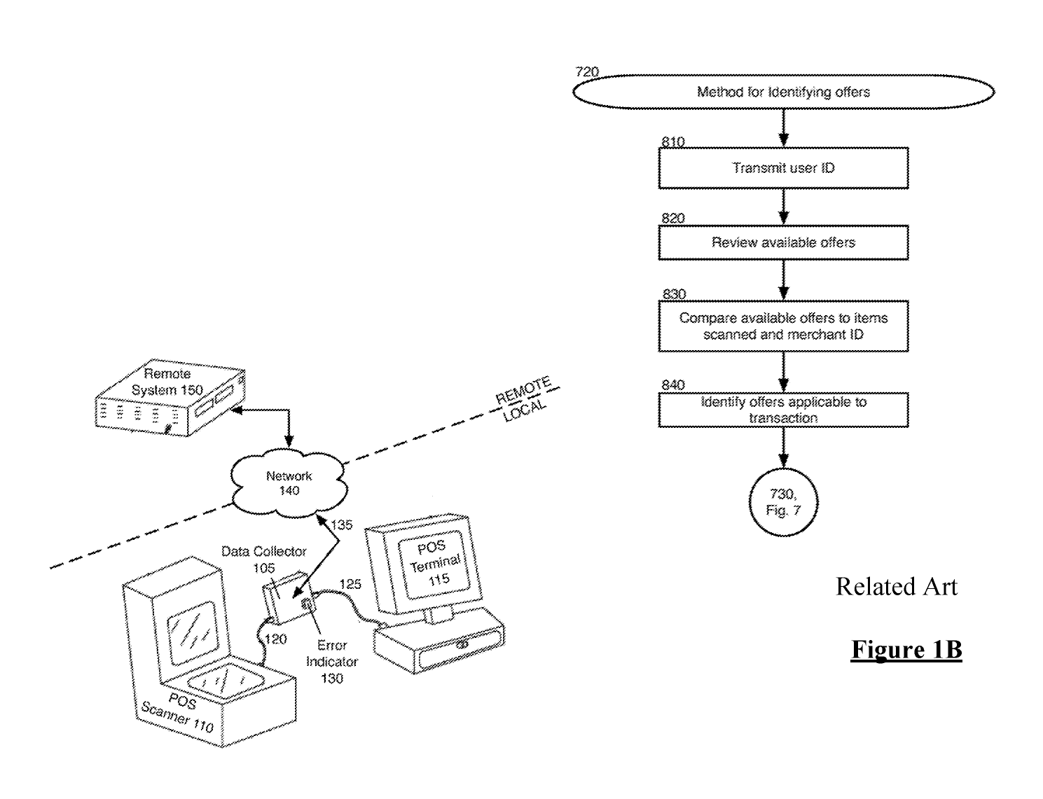

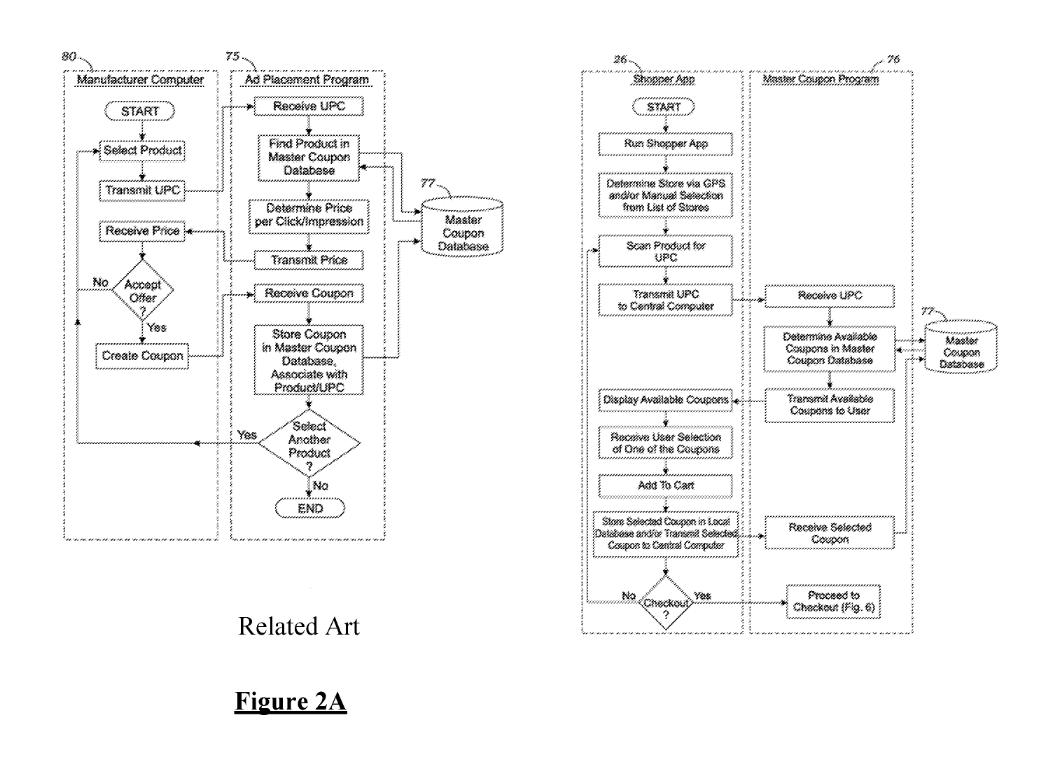

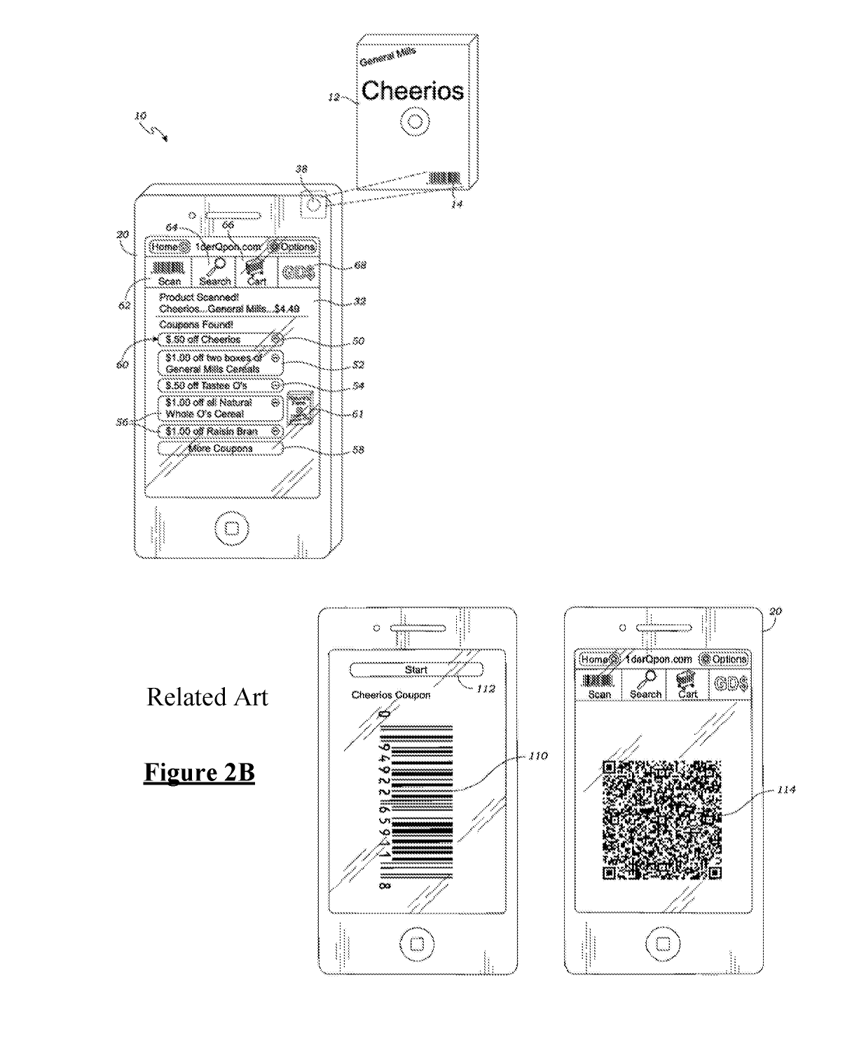

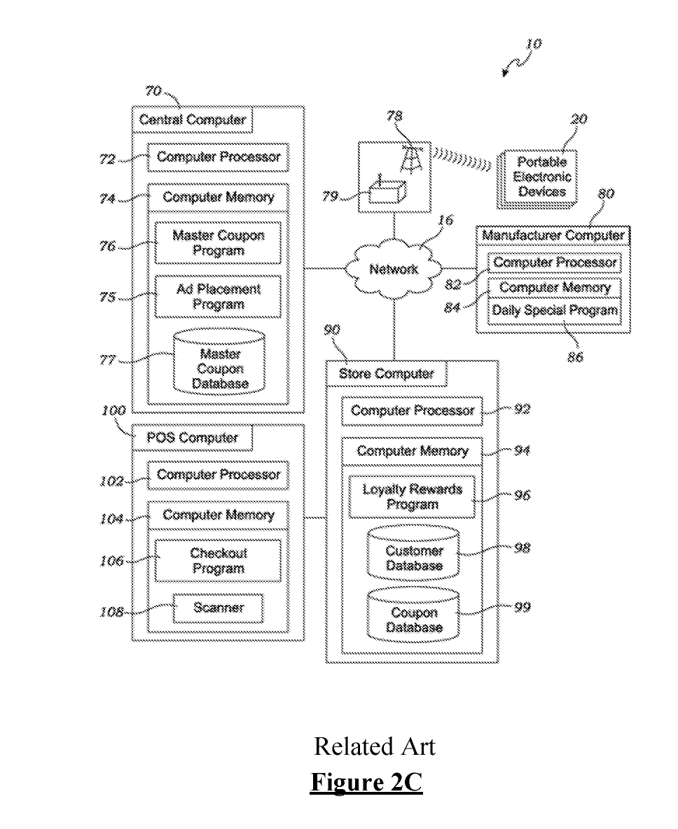

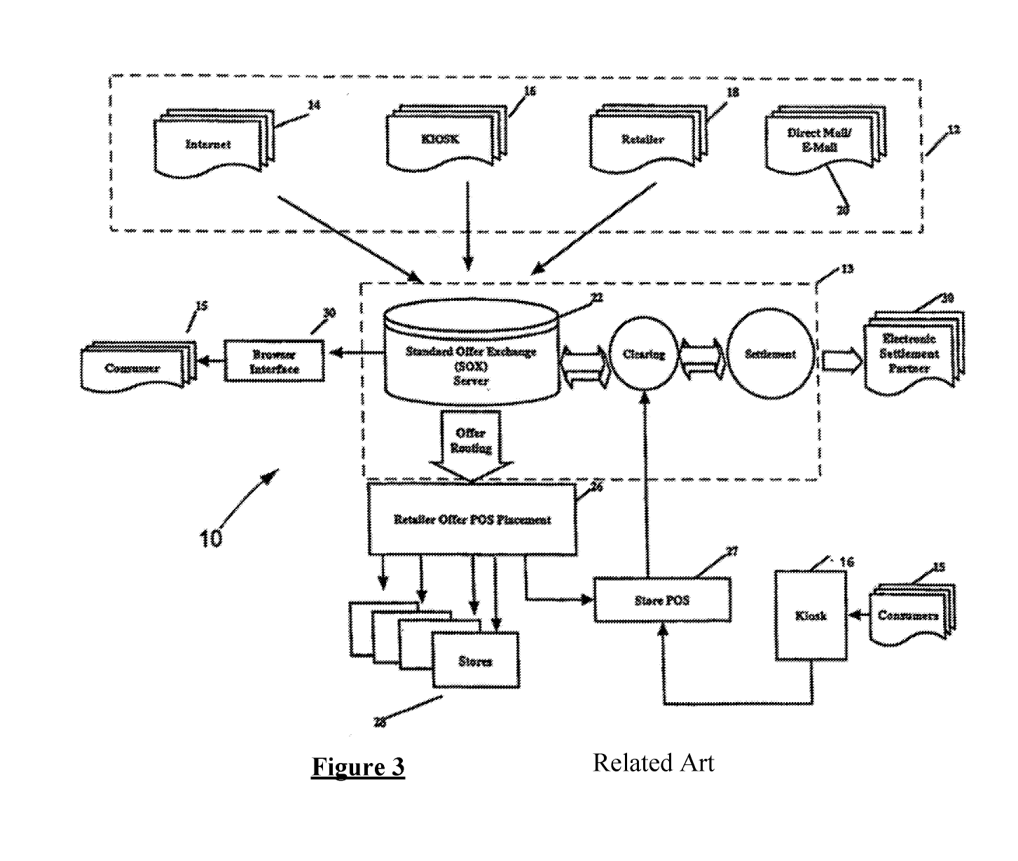

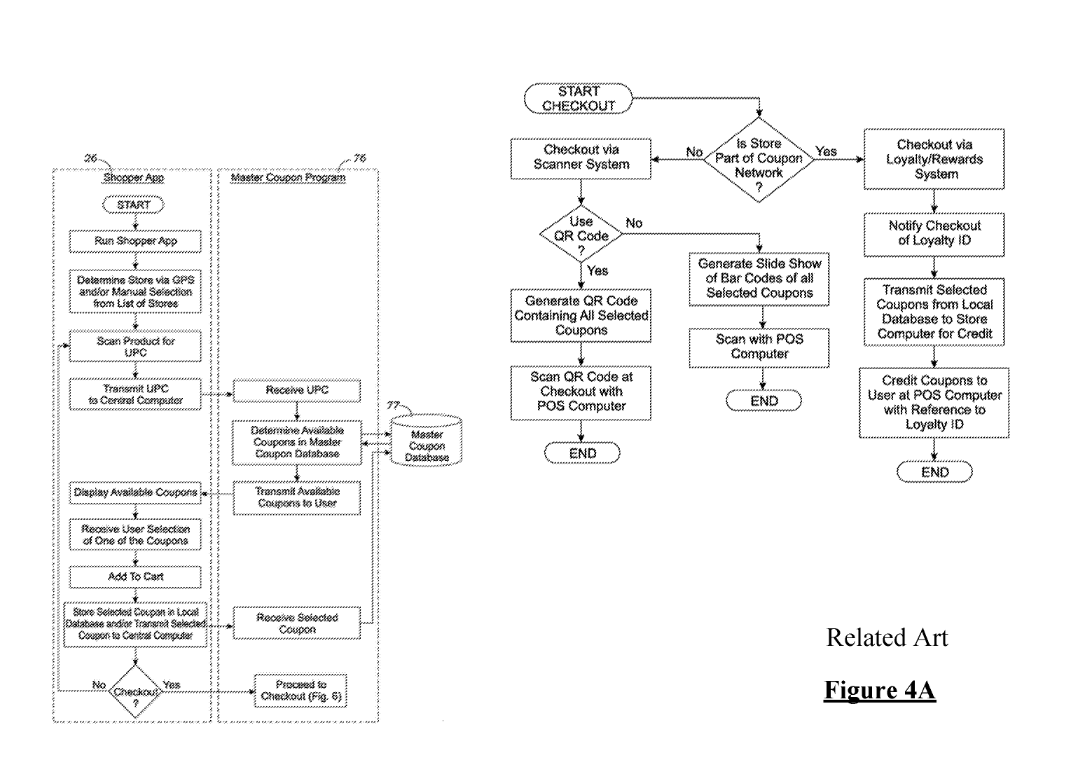

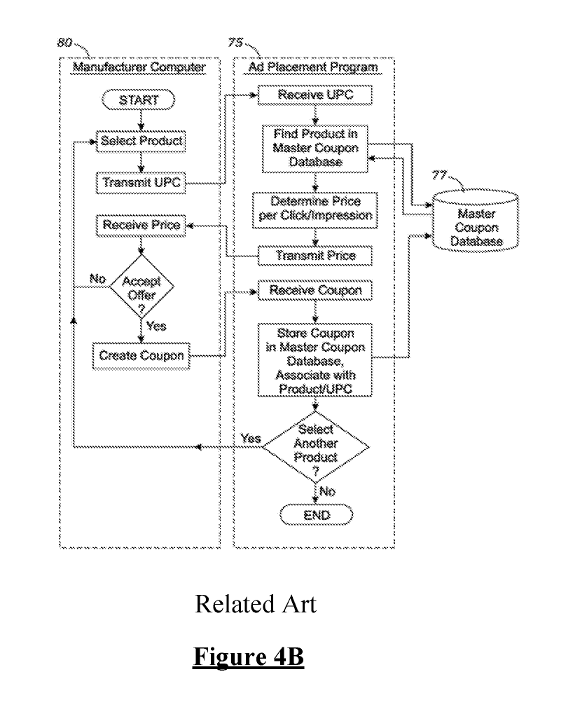

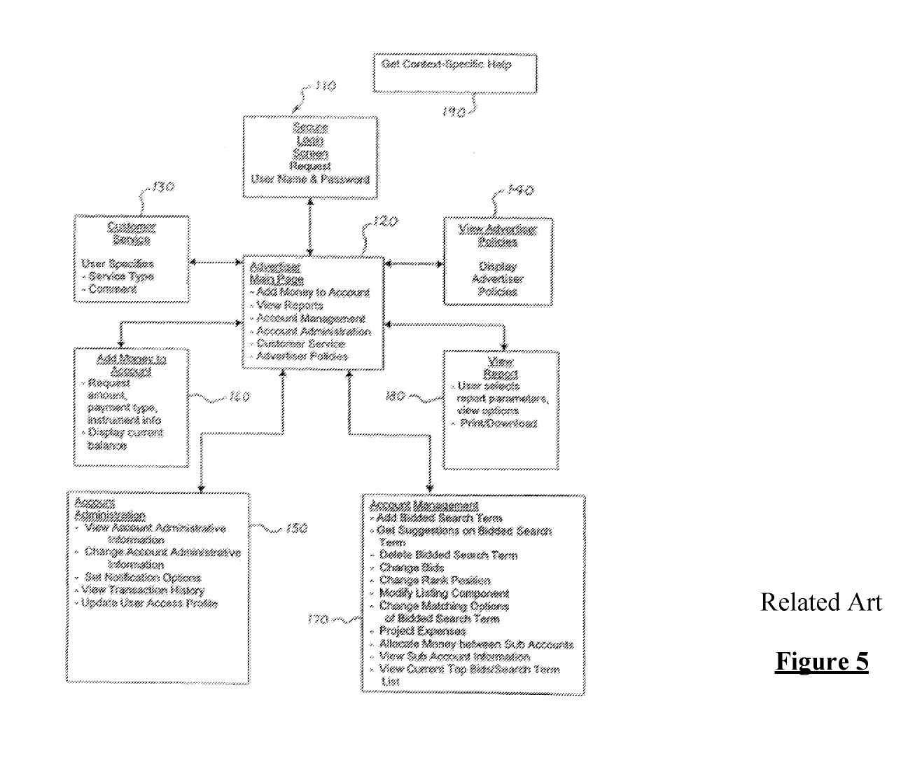

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

In general, the technology disclosed is directed to a product (e.g., UPC) marketplace (e.g., an online exchange, online auction, etc.). More specifically, the marketplace allows a manufacturer to bid on a specific product UPC and thereby obtain an entitlement to provide a coupon to a consumer that is considering to purchase a product related to that UPC or to a consumer who has purchased that given UPC product. The term manufacturer may be, in certain contexts, synonymous with the terms provider, seller, user, marketer, bid manager (BM), etc. As such, throughout the present document, the above-described terms are to be interchangeable in certain contexts. A coupon, may for example, provide the consumer with a percentage discount (e.g., 10% off of retail price, 50% off of each item when two of the same items are purchased, which is the same as a 2-for-1 coupon, etc.) or a specific dollar amount discount (e.g., $1.00 off of a specific item).

There are many ‘bidding components’ that will be considered for a successful bid such as value of the coupon to the consumer and price paid by a manufacturer. Bidding can be conducted programmatically. Manufacturers monitor results through a dashboard and can react quickly to market conditions. For example, in an implementation the manufacturer may be provided with an option to elect (e.g., the manufacturer is provided with an election) whether or not to deliver a coupon to a consumer if the manufacturer has won a bid that enables the manufacturer to send a coupon (or have a coupon sent) to the consumer. In another implementation, the manufacturer, once provided with an election after winning the bid, may determine other aspects of the coupon, such as value, etc., based on various criteria related to the consumer. The manufacturer can implement a defensive marketing strategy by electing to not send a coupon to the consumer. This can be achieved, by example, providing the election results to the winning bidder (e.g., manufacturer) and allowing the winning bidder (e.g., manufacturer) to make an election as to which action to take next (e.g., not send any coupon, or send a specific type of coupon, etc.). Consumers can see coupons across personal computing devices, mobile devices, etc. and can access coupons using, for example, a proprietary “12 Digit Media” consumer application or an application provided by a retailer (e.g., grocery retailer), but coupons can also be delivered by other means (e.g. email, printed delivery at a POS). The term retailer may be, in certain contexts, synonymous with the terms seller, physical store, user, retail outlet, etc. As such, throughout the present document, the above-described terms are to be interchangeable in certain contexts. The term consumer may be, in certain contexts, synonymous with the terms buyer, customer, purchaser, user, etc. As such, throughout the present document, the above-described items are to be interchangeable in certain contexts. Benefits of this above-described structure include financial incentives to the retailer, precision targeting of consumers by manufacturers at a granular UPC level and based on, for example, remnant UPCs, and more timely and relevant coupons to consumer.

In order to address the above-described issue of providing non-targeted promotional campaigns that are wasteful in terms of expense, effort and time, the technology disclosed provides systems and methods for targeting coupons. For example, if General Mills® knew who the consumers of Cheerios® (a General Mills® product) were and knew who competitor (e.g., Froot Loops®, from Kellogg's® cereal buyers were, General Mills® could distribute a coupon directly to a targeted consumer and avoid printing and distributing millions of coupons nationwide to consumers who do not purchase in this cereal category. Likewise, if Kellogg's® wanted to have its coupon delivered directly to the General Mills® consumer/purchaser to attempt to convert the consumer to a Kellogg's consumer/purchaser, better targeting methods should be utilized.

In one example, the actions of the consumer, such as the purchase of a cereal at a retail outlet, can trigger the printing of a coupon at the POS. This is a highly valued source of information, and can receive a CPM of $100+(i.e., $100+ per thousand coupons). However, this methodology is currently used for only 1.1% of coupon distributions (2014 Inmar Coupon Trends Report, http://go.inmar.com/rs/inmar/images/Inmar_2014_Coupon_Trends_Report.pdf). In this example, there is an opportunity for a market to sell the rights to distribute coupons upon the purchase trigger.

Specifically, the technology disclosed provides a marketplace (e.g., online exchange) that allows General Mills® to bid for the right/entitlement to distribute a coupon to someone who buys a product with a scanned UPC number (e.g., a UPC-A, which is the most common version of UPCs) of 0 16000 27526 3, which is the 8.9 oz. box of Cheerios®. As well, Kellogg's® can also bid for the right to distribute their coupon for Corn Flakes® to the consumer who just purchased the 8.9 oz. box of Cheerios®. The technology disclosed not only allows for this form of distribution and redemption of electronic coupons, but can support the distribution of coupons as the consumer browses the retail store shelves. Additionally, alternate types of promotions, such as display or product videos can accompany the electronic coupons, which can increase the value of the transaction to the consumer, the retailer, and the manufacturer.

Furthermore, in order to address the above-described issue of manufacturers not having access to retailer's data regarding transactions with consumers, the technology disclosed provides a marketplace whereby manufacturers can identify categories and products (by UPC or some other barcode such as EAN, ISBN) that consumers will be considering and/or purchasing in a future period, and bid to win the right to deliver a coupon to that consumer related to the product barcode.

Specifically, the technology discloses is a system and method for enabling manufacturers using a computer network such as the Internet to enable them to: (i) develop sophisticated promotional coupon campaigns at the consumer level (e.g., UPC granular level) based on the scan of a barcode through a POS system; (ii) bid and pay based on, for example CPM, cost per redemption (CPR), etc.) for placement/delivery of coupons to these consumers; (iii) deliver to the consumer via an online means (e.g., digital coupons) and/or offline (e.g. printed coupons and direct mail); (iv) get detailed manufacturer analysis and deep insights into conversions (e.g., coupons that are used by the consumer to obtain a discount), value and ROI at the UPC level; and (v) get detailed retailer analysis and deep insights into manufacturer spending and category growth metrics.

The system and method of the present technology disclosed provides a database having brands for each manufacturer (e.g., provider, deliverer, etc.) of products/goods. The manufacturer influences distribution of their coupon to a consumer through a continuous (e.g., ongoing) online competitive bidding process, or through an online bidding process that ends at a specific time (e.g., the bidding process may end after a day, week, month, etc. from commencement). The bidding process occurs when the manufacturer transacts in the marketplace by entering “bidding” components for a given UPC listing (at the UPC granular level) or for a collective grouping of numerous UPCs (still can be at a UPC granular level) in a given category/subcategory. For example, the collective grouping of UPCs can be directed to a specific group of UPCs that are related to a single specific UPC or another group of UPCs. Each brand of the manufacturer may have contact and billing information for the manufacturer and each of the manufacturer's brand UPCs associated therewith. When the manufacturer enters the marketplace (e.g., an online exchange, an online auction, etc.) and wants to bid on a given UPC or set of UPCs, they submit numerous “bidding components.” These components will enable algorithms to be implemented by the marketplace to pick winning bids and/or a winning bidder. As discussed in more detail below, the winning bids and/or winning bidder may be chosen simply based on the highest bid or may be chosen using factors other than only the bid amount (e.g., relevancy of bid, estimated redemption rate, etc.). As such, the bidder with the highest bid may not always be the winning bidder, because of the above-described factors that can be taken into consideration when determining the winning bidder.

Specifically, in an implementation, the marketplace can provide the following: the specific UPCs or coupon codes of all the products that the manufacturer wants to trigger a coupon on; a dollar amount based coupon unit to be provided to the consumer; determination of how many products need to be purchased to redeem a coupon; an expiration date of the coupon; creative components of the coupon; a desired quantity of impressions (e.g., coupons delivered) to be purchased/budgeted; and a bid amount range (e.g., a starting price, a maximum bid, etc.). The system and method of the present technology disclosed then enables scoring of every manufacturer bid request and compares all bid amounts for the same UPC or UPCs and terms associated therewith, along with additional data that can be useful to improve consumer relevance and satisfaction including redemption rates, and generates a rank value for all relevant bids. The rank value generated by the bidding process determines if and where the manufacturer's coupon will be delivered to the consumer in response to, for example, a scan performed by a POS terminal located at a retailer.

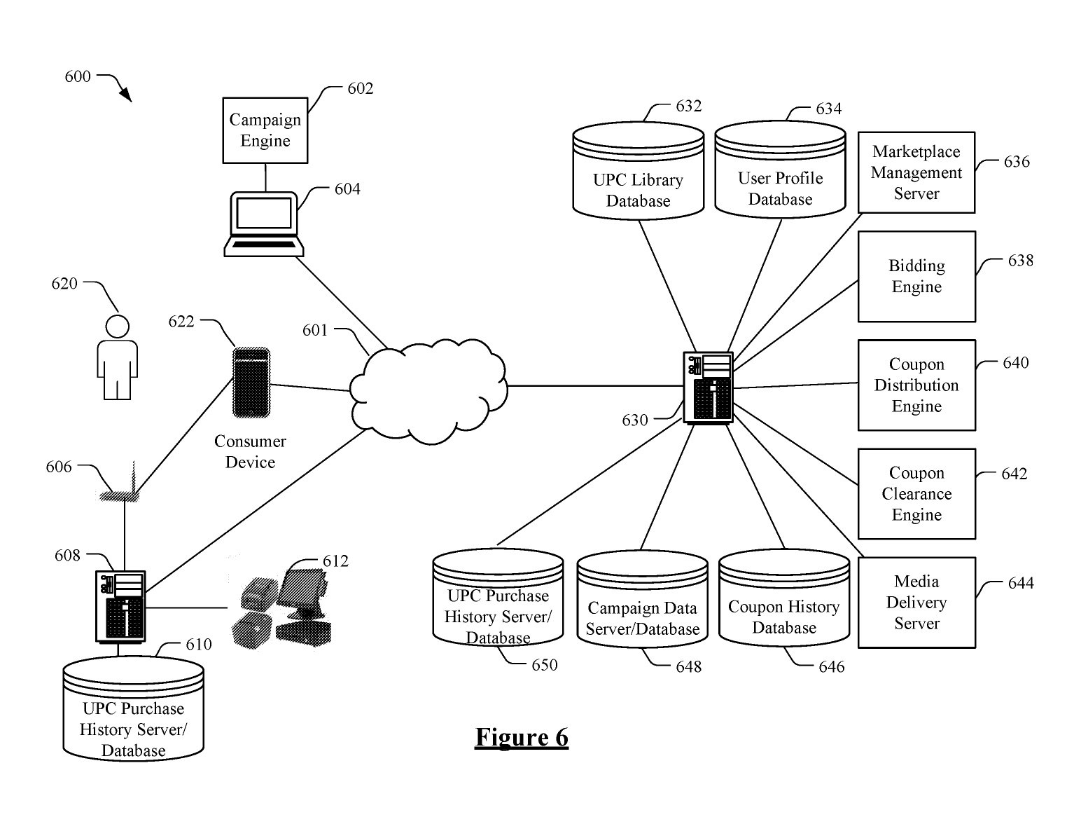

FIG. 6 illustrates an example of an infrastructure for providing targeted coupons to a consumer by interfacing with a manufacturer, a retailer and a consumer, according to an embodiment of the present disclosure.

Referring to FIG. 6, a system 600 is illustrated for providing targeted coupons, where the system 600 interfaces with a consumer, a manufacturer and a retailer via a network 601. Specifically, the system 600 includes a marketing computer 604, a server (e.g., a 12 Digit Media services server and/or servers) 630, a retail server 608 and a consumer 620 connected via a network 601.

The marketing computer 604 includes and executes a campaign engine 602, which can be hosted by, for example, the server 630. In an implementation, the campaign engine 602 can simply be a portal and/or browser, for example, that allows the marketing computer 604 to obtain and present information that is provided by the server 630. In another implementation, the campaign engine 602 may provide functionality that is beyond a portal and/or browser, such as performing operations based on information received from the server 630. Further, the server 630 includes and/or is connected to a UPC library database 632, a user profile database 634, a marketplace management server 636, a bidding engine 638, a coupon distribution engine 640, a coupon clearance engine 642, a media delivery server 644, a coupon/UPC history database 646, a campaign data server/database 648 and a UPC purchase history server/database 650. The entities included in or connected to the server 630 may be implemented as a single entity or as multiple entities and may not be limited to the functionality/structure described below and may perform the functions of other entities connected to the server 630. For example, any one of the above-described databases may be implemented by one or multiple databases, each being centrally located or each having different physical and/or virtual locations.

Further, the retail server 608 includes and/or is connected to a NFC device 606 used by retailers to communicate with the consumer 620 within or near a facility of the retailer, a POS terminal 612, and a UPC purchase history server/database 610. In an implementation, the retail server 608 manages many or all of the retail services required for consumer 620 purchases and coupon redemption, and can communicate with the server 630 via the network 601.

In an implementation, a marketer (e.g., a manufacturer, a brand manager for a manufacturer, etc.) logs into the marketing computer 604 (e.g., a bidding terminal) to execute the campaign engine 602. The marketer can be directly employed by the manufacturer, or can have an arm's length relationship with the manufacture. The campaign engine 602 is the marketer's interface (e.g., portal) to the (coupon marketing) system 600, where the marketer can access a marketplace and create an account by inputting various fields of information. The marketer can then authenticate themselves and log into their confidential marketplace section. The marketer can search the UPC library database 632 for a specific category and sub-category of UPC codes, down to a UPC granular level, for which the manufacturer wants to bid. The marketer can also search the UPC library database 632 for a collection of UPCs, such as remnant UPCs for which coupon delivery/exclusivity have not yet been sold, as targets for coupon delivery.

A marketer is allowed to see all available data in their allowable categories and can run inventory analysis (e.g., view all brands, subsets/subcategories of brands, available inventory, etc.) on their allowable categories for the upcoming weeks. The marketer can pick and edit UPCs by category, subcategory, defined competitive set, and choose any exclusions such as large size, etc. The marketer can also set campaign location settings to define location/geography, and can input fields such as budget, min/max bid, expiration date, coupon amounts, type of bid (CPM, CPR, etc.).

There are many options for bid strategies, such as manual versus automatic, campaign or group bid strategies, and flexible bids. A marketer can either pick every coupon value manually or run an automatic process and set up and edit as appropriate.

In another implementation, the marketer can enter the UPCs of the products they are promoting and their campaign goals such as cost per redemption, etc. A campaign wizard of the campaign engine 602 can use and/or utilize information from the coupon/UPC history database 646 and use and/or utilize predictive algorithms within the campaign data server/database 648 (which stores various information regarding previous and current campaigns, where collaborative filtering of other successful or unsuccessful campaigns may be performed) to recommend and/or obtain recommendations of UPCs (of, for example, remnant UPCs) to target. The marketer can review lists of all category/sub-category with all available UPCs in the UPC library database 632 and select or deselect those UPCs, including their own, that they want to use as triggers. The coupon/UPC history database 646 can be used to generate projections on quantities of impressions (UPCs scanned) in an upcoming period of time such as, for example, the next few weeks. These projections can be used as input into (e.g., provided as information to be displayed using) the campaign engine 602 and my include: (i) capital budgets based on coupons delivered; (ii) capital budgets based on number of coupons redeemed; (iii) capital budgets based on units sold based on redemptions; (vi) an ability to help pace budgets evenly over some given number of days; (v) a budget for each UPC selected; (vi) a budget for the entire portfolio of UPCs or a specific group of UPCs; and (vii) altered budgets based on estimated ROI metrics.

Furthermore, other information can be entered into the campaign engine 602, such as: (i) a product graphic; (ii) a description; (iii) a coupon value; (iv) a quantity required for redemption; (v) a start date; (vi) a coupon expiration date; (vii) special terms or conditions; and (viii) a bar code for redemption. As discussed above, in an implementation, the campaign engine 602 may simply be a portal and/or browser to the server 630 that allows the above-described information to be sent to the server 630 using the marketing computer 604.

A user (e.g., a manufacturer, marketer, brand manager, etc.) that uses the marketing computer 604 can place/design a bid request based on one or more bid criteria such as cost per coupon delivered, CPM, CPR, guaranteed placement, guaranteed delivery, cost per incremental coupon redeemed, cost per incremental unit sold, tiered bids based on hitting specific volumes of the above metrics, frequency capping of delivered coupons, so that, for example, a consumer is limited to receiving the same coupon only a certain number of times over a certain time period.

The campaign wizard of the campaign engine 602 and/or presented using the campaign engine 602 as a portal/interface can run algorithms using the inputs from the user as well as historical response rates for a category or specific UPS for this particular user along with consideration of other competitive bids already in the system 600 or anticipated upcoming bids based on historical patterns. The user can receive outputs and campaign suggestions such as: (i) an estimate of a likelihood of winning the bid (e.g. 25%, 50%, 75% or high/medium/low); (ii) an estimate of a quantity of winning bids at a given budget, with the current campaign inputs of coupon value and bid price; (iii) total impressions won/delivered and campaign dollars spent versus budget; (iv) an estimate of projected CPR; (v) an estimate of cost per incremental units sold based on assumptions about incrementally of past campaigns at the UPC granular level or at a group UPC level; (vi) suggestions for new inputs to increase chances of winning bid; and (vii) suggestions of alternative campaigns (e.g., different/revised triggers, different coupon values, etc.) to meet the user's objectives.

Campaign reporting provided at marketing computer 604 at the UPC level or group level can include: impressions/coupons delivered; coupons redeemed by a specific trigger or triggers; trending redemption rates by, for example, coupon value, expiration date, units required for redemption, geography, number of bidders, and number of coupons available in the category; and optimal campaign design based on a combination of the metrics above resulting in the most units moved at the least cost. This campaign reporting can be provided at the marketing computer 604 via the campaign engine 602 providing and/or acting as a portal/browser to the server 630.

A user interface (e.g., a bidding interface) can be provided by the campaign engine 602 and the marketing computer 604, from and/or using information provided by for example, the server 630, and may include the following list of activities: account login; select from predetermined campaign objectives; select a UPC or UPCs for targeting; budgeting and cost/performance estimates; campaign setup; coupon creation; launch campaigns; campaign reporting; bid optimization; real-time optimization recommendations; and campaign completion diagnostics and insights.

The marketplace management server 636 of the server 630 manages the overall process for bidding, coupon distribution, coupon clearance, and so on, by interfacing with, for example, the marketing computer 604 including the campaign engine 602 acting as, for example a portal and/or a browser. In some implementations, the campaign engine 602 may simply be a browser or portal that allows the marketing computer 604 to communicate with the server 630 and connect to the marketplace (e.g., online exchange) provided by the server 630. Further, the bidding engine 638 can be used by competing manufacturers, via for example other marketing computers 604 (e.g., bidding terminals) to bid on campaigns, UPCs, groups of UPCs, etc. defined and/or presented by the campaign engine 602.

Using the marketplace management server 636 and/or the bidding engine 638, manufacturers can submit bids that include information such as their brand, a list of all the UPCs they wish to trigger and deliver a coupon to a consumer that purchases a product having the triggering UPC or UPCs, a timing date of a start/end of the delivery of the coupon, a minimum and maximum bid price (e.g., CPM, CPR, cost to load coupon to loyalty/frequent shopper card), coupon requirements (e.g., money discount and purchase requirements), geography and budget.

The bidding engine 638 and/or the marketplace management server 636 provide the bidding interface for the manufacturers. This bidding interface provides each manufacturer with a (online) user interface for creating manufacturer specific accounts, entering bids and managing campaigns. Each manufacturer can do this using their own marketing computer 604 (e.g., bidding terminal). In an implementation, for example, a user (e.g., manufacturer) must first create an account and then create a campaign. The campaign may, for example, identify a specific start date, identify a specific end date, identify a specific target (e.g., a specific UPC or a group of UPCs from an available collection of UPC data and/or remnant UPC data), specify a coupon amount/percentage and provide an interface for submitting a bidding price or prices. Further, by using the bidding interface, a user can view campaign results real-time and use the results to optimize future campaigns. The bidding interface may be provided to the user by way of a graphic user interface provided by the marketplace management server 636 and/or the bidding engine 638 or may be provided to the user by way of an application programming interface (API).

The bidding interface may also provide input fields related to the user (e.g., manufacturer) account and related to the manufacturer's campaign(s). For example, regarding the user account, the bidding interface can provide input fields for a “user name,” a “password,” an “email address,” a “company name,” an “address,” and “payment information.” Regarding the campaign, the user can be provided with input fields so that the user can input a “campaign name,” a “start date,” and “end date,” “a campaign objective,” a “target UPC list,” a “bid price” (e.g., CPM or CPR), a “maximum spend per day,” a “total spending limit,” and “coupon details.” Additionally, in an implementation, the bidding interface will allow the user to specify a coupon value, an image related to the coupon, and a UPC of a product or related to the product of the coupon.

In an implementation, the bidding interface can provide, as discussed above, campaign results. The campaign results can include/identify various metrics, such as coupons delivered to consumers, a number of unique users receiving a coupon, a number of coupons redeemed, a redemption rate of coupons (e.g., coupon redeemed divided by number of unique consumers), a total amount of money spent on a campaign, a cost per coupon delivered (e.g., total amount spent on a campaign divided by the number of coupons delivered) and a cost per unit sold (e.g., a total amount spent on a campaign divided by the number of coupons redeemed).

Furthermore, in an implementation, the metrics can be provided to the user via the bidding interface based on activity during a specific time period (e.g., between two specific dates), based on activity for a specific UPC or UPCs, based on a general category or based on a specific retailer or retailers.

During a bidding process, bids of manufacturers can be scored, ranked and prioritized for delivery based on the following sample collections of algorithms: (i) bid rate/amount (e.g., highest bid for delivery of a coupon); (ii) bid rate/amount×historical or projected redemption rate; (iii) (bid rate/amount×redemption rate) (dollar value of coupon discount/# of items required for redemption); and (vi) (bid rate/amount×redemption rate)×(% discount off average retail price). In other words, the bids (e.g., bid scores) can be tracked by the server 630 so that the server 630 can determine the winning bidder at the appropriate time. Note that a redemption rate can be a proxy for understanding loyalty. The ranking of the various bids can be based on one or all of the above-described algorithms to develop a bidding score (e.g., the above-mentioned bid-scores) for each of the participating manufacturers and then the winning bidder can be determined at the appropriate time.

Additionally, manufacturers can utilize the marketplace management server 636 and/or the bidding engine 638 on a daily, weekly or monthly basis and bid for delivering coupons the following period without the typical multiple month lead time required by offline and newspaper FSIs.

Manufacturers can also test a myriad of campaign strategies (e.g., price discount by UPC) and view response and redemption metrics on a daily basis in dashboards provided by the marketplace management server 636 to measure ROI and apply real-time test and learn methodologies used by successful interne models as search engine marketing with Google Adwords®. This can be accomplished because this bidding process is implemented as an ongoing online auction for determining winning bidders.

In an implementation, the marketplace management server 636 can receive all of the campaign data, account data and bids from the bidding interfaces, as provided by the manufactures involved in the bidding process. The marketplace management server 636 then prioritizes/orders the bids from the manufactures based on the above-described scores and also, for example, based on relevance and value to the consumer. The above-described algorithms can be adjusted, for example, to give higher priority to certain of the above-described factors, such as bid rate/amount. The manufacturer having the bid with the highest priority can then be notified and the retailer/consumer will be provided with the appropriate coupons at the appropriate times. Since, this bidding process can be implemented as an ongoing (e.g., continuous) online auction, the winning bidder may be determined just after the consumer scans the targeted (remnant and/or non-remnant) UPC as the POS terminal 612. After the winning bidder is determined, the coupon(s) will be delivered to the consumer 620 via the server 630 by way of the retail server 608 and the POS terminal 612. Alternatively, the coupon(s) may be delivered to the consumer 620 in an electronic format, as discussed in further detail below. In an implementation, only a predefined/predetermined maximum number of coupons may be delivered to the consumer based on each visit to the POS terminal 612, where the predefined/predetermined maximum number can be different based on the type of delivery. These features will allow the consumer to only be eligible to receive, at most, a certain number of coupons and/or messages as a result of the scanned UPCs. For example, there may be a maximum of 5 printed coupons and a maximum of 25 electronic coupons delivered to the consumer per visit to the POS terminal 612 for purchase. In view of the above, a scenario exists where there could be 50 UPCs scanned by the consumer that are eligible for coupons, but only 5 (e.g., the top 5 of the 50 eligible) will be delivered in print form to the consumer. The top 5 may be determined using, for example, a bid score as discussed below in more detail.

Alternatively, in an implementation, the marketplace management server 636, the bidding engine 638, etc., may provide the manufacturer with a notification indicating that they are the winning bidder and may also provide option to elect (e.g., the manufacturer is provided with an election) whether or not to deliver a coupon to a consumer if the manufacturer has won a bid that enables the manufacturer to send a coupon (or have a coupon sent) to the consumer. For example, the manufacturer can implement a defensive marketing strategy by electing to not send a coupon to the consumer. This can be achieved, by example, providing the election results to the winning bidder (e.g., manufacturer) and allowing the winning bidder (e.g., manufacturer) to make an election as to which action to take next (e.g., not send any coupon, or send a specific type of coupon, etc.).

In an implementation, the marketplace management server 636 receives campaign rules via the bidding interfaces utilized by the manufactures. Further, for example, the UPC purchase history server/database 610 and/or the UPC purchase history server/database 650 can be accessed by the marketplace management server 636 to build a list of potential coupons for each manufacturer based on targeting criteria provided by the corresponding manufacture in the bidding process. In an implementation, the UPC purchase history server/database 610 can be a copy of the UPC purchase history server/database 650 and vice-versa. Accordingly, the marketplace management server 636 can access the UPC purchase history server/database 610 and/or 650 to build the list of potential coupons for each manufacturer based on the targeting criteria. This list of potential coupons can include a user ID, a coupon ID, a start date, and end date and coupon details. Any changes that are made to the potential coupon list can be published to the media delivery server 644 in real time.

The media delivery server 644 supports the delivery of coupons. Specifically, in an implementation, the media delivery server 644 can send each coupon to the server 630 as they are received from the marketplace management server 636 and the server 630 may send each coupon to the retail server 608 and/or the consumer 620 if/when appropriate.

As previously mentioned, the campaign data server/database 648 can store information related to previous (e.g., historical) campaigns and ongoing campaigns. For example, the campaign data server/database 648 may store a campaign identification and information related thereto, such as event type, coupon(s) viewed/received, coupon(s) redeemed, UPC(s) triggering coupon(s), dates and times related to the coupon(s) and retailer identification associated with the coupon(s).

The consumer 620 may receive the coupon from the POS terminal 612 (e.g., a printed coupon) or may receive the coupon by using an application (e.g., a 12 Digit Media application) that is installed on a handheld computer, table or smartphone (e.g., consumer device 622) of the consumer 620.

In an implementation, the application installed on the consumer device 622 is capable of storing and displaying coupons targeted to the consumer 620. The application can further utilize the consumer device 622 to communicate with the retail server 608 via the POS terminal 612 and/or the NFC device 606, for example. In another implementation, the application can utilize the consumer device 622 to communicate with the server 630 to transmit/receive past user history and current/past coupons. This application facilitates the easy redemption of one or multiple manufacturer coupons from one application of one device 622. These coupons may also be accessible from multiple consumer devices for the convenience of the consumer 620. As an alternative to the application, the coupons can be provided to the consumer 620 using online networks, email, direct mail, third-party applications and other user wearable devices.

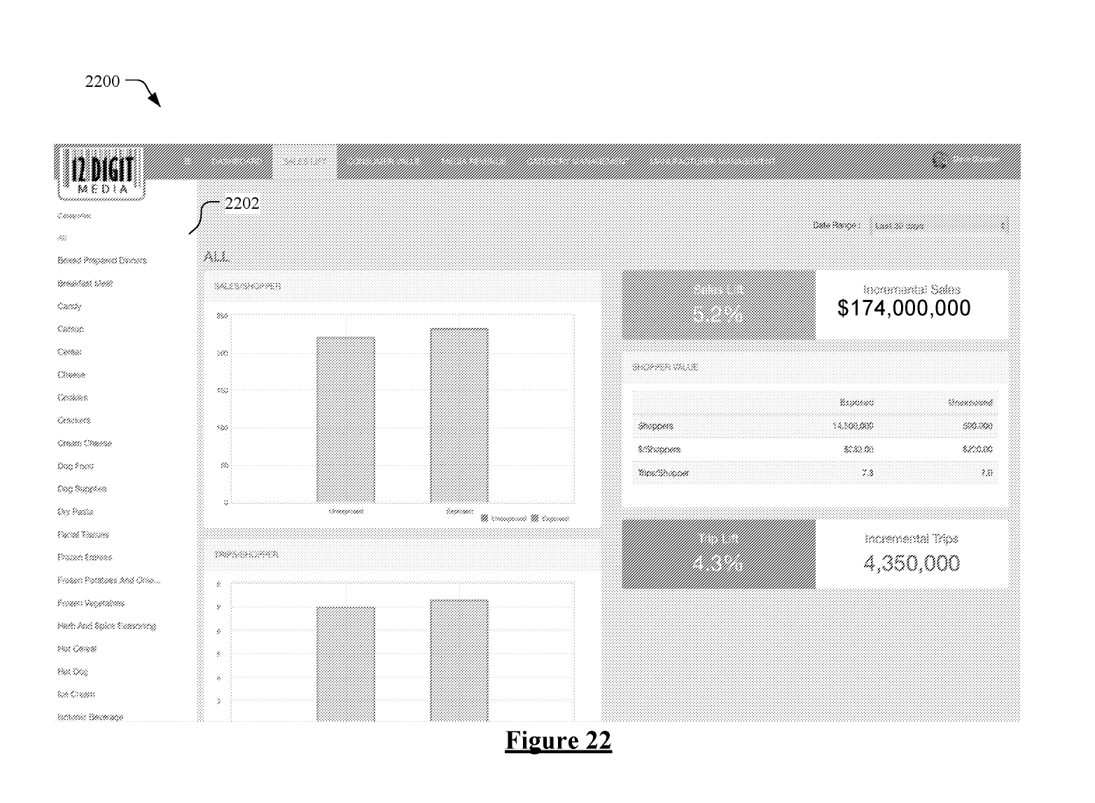

The application installed on the consumer device 622 may also allow the consumer 620 to create a user account, search for coupons, view coupons based on different criteria, such as expiration date, product category, value, manufacturer and issue date. Further, the application can also allow the consumer 620 to obtain previous purchase history from the retail server 608, via, for example, the NFC device 606 and/or the POS terminal 612, and also can allow the consumer 620 to transmit coupon information to the retail server 608 for each relevant item purchased and/or keep track of coupon value(s) owed to the consumer 620 for direct payment to the consumer 620 from the server 630. In an implementation, the retailer may also be provided with an application and/or access to information provided by the server 630 to track and monitor the results of various campaigns and information associated therewith. Various aspects of the information that can be tracked by the retailer are discussed below with respect to FIG. 22.

In an implementation, the coupon distribution engine 640 distributes coupons to the consumers (e.g., the consumer 620) identified as targets for a campaign.

In an implementation, the coupon clearance engine 642 records when coupons have been redeemed for each purchase.

The UPC purchase history server/database 610 records consumer 620 purchases by UPC number, and all associated coupons. For example, the UPC purchase history server/database 610 can store, in association with a unique user (e.g. the consumer 620) identification, the UPCs of items purchased by the consumer 620, the UPCs of items for which associated coupons are available or have been redeemed, purchase dates and whether or not a coupon that is available to the consumer 620 has been redeemed. From this above-described information stored by the UPC purchase history server/database 610 and/or 650, determinations can be made as to the likelihood of the consumer 620 redeeming a coupon and the likelihood or propensity that the consumer 620 will switch products based on their lifetime history and value. Further, the UPC purchase history server/database 610 can reside on the retailer side (e.g., can be connected to the retail server 608), may reside as a part of a services suite of the server 630 or may be a copy of the UPC purchase history server/database 650 connected to the server 630 (as discussed above, the UPC purchase history server/database 610 may simply be a copy of UPC purchase history server/database 650 or vice-versa). The UPC purchase history server/database 610 may receive various UPC and/or coupon related information from the consumer application via, for example, the network 601 or through a connection to a POS backend system (not illustrated).

In an implementation, the POS backend system (not illustrated) may include servers and/or databases connected to the UPC purchase history server/database 610 in order to transmit UPC purchase information (e.g., historical purchase information) in a situation where a connection between the POS terminal 612 or the NFC device 606 and the application installed on the consumer device 622 is not available.

The POS terminal 612 is capable of recording purchase transactions of the consumer 620 and can scan for bar codes provided by the application installed on the consumer device 622. In an implementation, the POS terminal 612 can trigger reconciliation of the coupon with the coupon clearance engine 642. This process can be performed electronically, so as to prevent the use of fraudulent paper coupons and to facilitate instant/fast manufacturer payments to retailers, who previously had to float the coupon value for months.

In an implementation, the user profile database 634 stores user profiles for various consumers (e.g., consumer 620), various manufacturers, and various retailers utilizing the system 600.

In another implementation, the server 630 hosts and/or provides the functionality of any portion or all of the UPC library database 632, the user profile database 634, the marketplace management server 636, the bidding engine 638, the coupon distribution engine 640, the coupon clearance engine 642, the media delivery server 644, the coupon/UPC history database 646 and the campaign data server/database 648. The server 630 can include a plurality of physical and/or virtual servers, which may or may not necessarily be in the same physical location. The plurality of physical and/or virtual servers may perform various operations and provide the functionality of each above-described elements and/or may provide interfaces to connect and/or connect with each of the above-describe elements.

An example implementation of defining a campaign using the above-described system 600 is provided below. A user interaction with the system 600 can be described from a perspective of a Brand Manager (BM), who can use the system 600 in a number of ways. In an automatic mode, the system 600 can pick a percentage discount (e.g., 25%, 50%, etc.) off of, for example, an actual retail price (ARP) rounded up to nearest nickel. A minimum bid amount can be suggested by the system 600 for competitive reasons, and the system 600 can pick a number of units and sizes through an algorithm included in the system 600.

As an example, the ARP for a 24 oz. unit of Cheerios® is $3.99. The Cheerios® BM picks 40% off of one 24 oz. unit. The associated discount is $1.59, so a coupon generated for the consumer 620 is $1.60 off one 24 oz. box. In contrast, the BM could pick all sizes of Cheerios®, so that the coupon generated is $1.60 off any size of Cheerios®. The above-noted algorithms can be programmed to determine a value of the coupon based on a discount for the smallest/lowest priced UPC, excluding any trial sizes. Additionally, the BM can use the above-described campaign wizard to help suggest numerous campaign strategies outlined above once key variables are entered such as financial objectives, CPR or cost per incremental unit sold. In other words, the bidding engine 638 may suggest bids to the BM, as well as reminders, estimated inventory, etc.

The BM can also query the marketplace through the marketplace management server 636 and get estimates of bidding win rates and impressions won for each of the campaign strategies. Further, the BM can input and upload various creative elements such as copy, fonts, images, graphics in predefined templates and wizards.

An example implementation of using the system 600 to go through a bidding process is provided below. The BM obtains an ability, via the bidding process, to provide a coupon against (e.g., targeting) scanned UPCs. In some implementations, the bid is for a fixed price per coupon or placement. In other implementations, the bid is a price per coupon redeemed. Bids that involve elements of market research will be on a fixed price, leaving the BM free to experiment with different coupons terms and values. Bids based on per coupon redemption will be subject to an evaluation that takes into account projected or actual redemption rates. In some implementations, coupons may be auditioned (e.g., via split or multivariate testing) to establish a base line redemption rate for bid evaluation and results of the auditioning can be presented to the BM.

As previously mentioned, the system 600 is capable of providing campaign analysis and management. Specifically, the campaign engine 602 in conjunction with the server 630 can also be used to perform and provide the campaign analysis and management. In an implementation, the BM can review any current or past campaigns (by results, average cost per redemption, average cost coupon, dollars spent and impressions served) per UPC, per UPCs, per category or per subcategory. The BM can run various campaign analysis reports (e.g. what was best performing coupon, CPR, etc.) for every UPC and/or every campaign at a macro or micro level.

In an implementation, the BM can also run reports on dollars spent to date, budget allotted and remaining budget available. Trend reports highlighting how the BM is doing month over month, projection reports showing likely available inventory on a weekly basis over the next 6 months, and analysis of the amount/percentage of inventory won/lost in any given inputted campaign period can also be created and presented to the BM.

In another example implementation, the bidding process implemented by the system 600 can have a hard stop time/date, for example, at noon on Thursday, Pacific Standard Time, each week. This format gives every participating manufacturer a fair opportunity before the hard stop time/date to review the status of their bids and to adjust their bids accordingly. This format will also give the manufacturers a specific deadline for implementing new strategies for the following week that did not work in the current/previous week. Alternatively, the bidding process may be configured to provide real-time bidding, with the bidding process ending each day or up to a point at which the consumer 620 has a product scanned at the POS terminal 612.

Further, in an implementation, the manufacturer bids can be evaluated using several different methodologies, such as impressions based, conversion based or both. Impressions based evaluations are performed based on the manufacturers' CPM bids and conversion based evaluations are performed based on predicted or actual experiential conversion rates (e.g., redemption rates of coupons) and combining a bid amount with the conversion rates. Redemption rates can be based on previous/prior redemption rates of similar coupons or based on specific consumer behavior gathered from historical data, such as data tied to a consumer's loyalty card associated with a specific retailer. Additionally, impressions based and conversion based evaluations can be combined and utilized for a bid by taking into account different targeting or delivery queues. Also, impressions based and conversion based evaluations can be combined and utilized for a bid by taking into account prices on impressions, but weighted by conversion rates (e.g., actual or predicted redemption rates) to improve a consumer experience and reliance on the system 600. For example, as a result of considering the above-described methodologies for evaluating bids, consumers and/or specific coupons having lower conversion rates may influence a result of a bid from a manufacturer (e.g., the bid score) and may influence a manufacturer's willingness to increase a bid amount.

In an implementation, the bidding process can provide a highly personalized interface, where bidding components and algorithms for developing the bid score can be provided to the manufacturers. Ultimately coupons should be highly personalized, relevant and valuable to each unique consumer. Rule sets and algorithms can be created to provide an “automatic curation” of coupons based on numerous factors including recency of category purchase, dollar size of past purchases and/or current purchase, percentage of retail cost savings provided via a coupon, expiration date and prior consumer redemption rates of similar coupons.

Additional implementations of the system 600 may include: (i) a bidding rights module (not illustrated) configured to provide built in marketplace protections that only allow a manufacturer to bid within their own pre-defined category (e.g., a laxative manufacturer may not be allowed to promote a coupon to non-laxative consumers or to a consumer who is not currently purchasing a laxative); (ii) a loyalty module (not illustrated) configured to provide built in marketplace protections that enable retailer specific rules around engaging consumer's loyal to a given brand (e.g., a retailer might not allow a Pepsi® coupon to be delivered to a loyal Coke® buyer); (iii) a gamification module (not illustrated) configured to provide a fun and engaging interface for manufacturers to bid and see results of their bid in terms of conversions and units moved; (iv) a campaign module (not illustrated) configured to provide a concept of enabling automatic and/or programmatic campaign creation of bids, so that a manufacturer can include, within a budget, campaign objectives (e.g., reach current in-market consumers, and launch a new product), and/or UPCs most important to the manufacturer in terms of targeting, and so that suggested campaigns can be instantly created using, for example, a wizard and can be instantly presented for approval; (v) a correlation module (not illustrated) configured to correlate various rule sets in order to eliminate redundancy (e.g., if a given consumer triggers the same coupon 3 times, the manufacturer only wants to deliver one coupon to the consumer during a certain time period; this is also referred to as frequency capping); (vi) a bid timing module (not illustrated) configured to introduce a concept of timing of how bids are placed, how manufacturers are alerted/notified if they are not going to have a winning bid enough times to reach the manufacturer's campaign budget and goals (e.g., the module can provide a notification to the manufacturer that the manufacturer needs to increase their bid by XX amount or increase a value of their coupon by YY % in order to be competitive); (vii) a distribution module (not illustrated) configured to determine which coupons to provide to each individual consumer based on the value of that coupon to that consumer, which can be determined based on other coupons the consumer has, a value of the coupon to be provided to the consumer and the value of the coupons owned by the consumer, a historical redemption rate of that consumer or like consumers identified using collaborative filtering, and configured to determine how to stack/rank/position a given coupon against other coupons in a same category; and (viii) an expiration module (not illustrated) configured to allow manufacturers to enter an expiration date and allow the system 600 to expire/remove coupons at the end of that date, configured to provide an alert mechanism for consumers to let them know that their coupons are about to expire, and configured to extend the expiration of a coupon if a consumer triggers the same coupon, or with a given rule set the system 600 might not extend the expiration date and instead show a coupon of a next highest bidding manufacturer.

Furthermore, in an implementation, fraud detection algorithms can be provided. The fraud detection algorithms may, for example, flag abnormal fluctuations (e.g., fluctuations of more than 20%) in metrics including: a redemption rate for each coupon; a number of coupons a specific consumer qualifies for; a number of coupons a specific consumer redeems; and multiple redemptions of a specific coupon from the same consumer. These fraud detection algorithms can be implemented using a fraud detection module (not illustrated) of the system 600.

Data security is an important feature of the system 600. Accordingly, in an implementation, data security of the system 600 can be increased by using encrypted communications between all components of the system 600 whenever a user (e.g., consumer 620) identification, a retailer identification, a manufacturer identification and/or a coupon code are communicated. Additionally, all locally stored data on a consumer device 622 that has previously communicated with or is currently communicating with the system 600 can be encrypted. Further, the system 600 can use industry best practices to secure all networks and servers utilized by the system 600.

The bidding engine 638 and/or the marketplace management server 636 can provide various alternative bidding options in some implementations of the present disclosure. Specifically, in an implementation, different bidding options can be provided, such as a standard bid and a performance bid. A standard bid is an amount a retailer is willing to pay to have a coupon delivered to the target consumer (e.g., expressed in terms of “cost per thousand coupons”). This type of bid can be used to provide premium guaranteed placement when there is limited inventory of a product (e.g., when there are only two or three manufactures of a particular type of product, the bidder will pay a premium to have the ability to target a coupon to each person that purchases that product). Additionally, this type of bid can be used to provide premium guaranteed placement of coupons at a future date, so that the manufacturer does not have to wait for bidding to commence and complete (e.g., the manufacturer may pay an upfront premium for an exclusive entitlement to deliver coupons to one or more targeted UPCs without having to go through the bidding process). A performance bid is an amount a manufacturer is willing to pay for each coupon redemption, where algorithms can be utilized to determine delivery and priority of each coupon for the winning bidder. This bidding and a winning bidder can be determined prior to the consumer 620 scanning a particular UPC or can be determined in real time at the time which the consumer 620 scans the particular UPC.

Further, in an implementation, the system 600 can include optimization algorithms for maximizing redemption rates for manufacturers and for maximizing the relevance to the consumers. This can be accomplished by using the optimization algorithm to prioritize coupons for each consumer. For example, each coupon can be scored for each consumer based on a calculated propensity of that consumer redeeming the coupon. Specifically, each coupon can be scored using, for example, any or all of the following variables: age; income; gender; zip code; past purchases in the category of the coupon; date since last purchase of the product for which the coupon is provided; past coupons redeemed; past coupons viewed; retailers shopped by the consumer in the past; a time of day; a day of week; a current geolocation (to identify which retailer(s) is/are relevant); presence/location of beacon signals (to identify which aisles the consumer has shopped or is currently shopping); crowd source historical redemptions based on consumers who received the same or similar coupon triggered by a single UPC or group of UPCs; and collaborative filtering used to prioritize coupons (e.g., other people who received a coupon triggered by the same UPC also redeemed these coupons). Higher scoring coupons can be, for example, more prominently displayed in the application running on the consumer's device 622.

Regarding payment to the retailers for the discount afforded to the consumers, in an implementation the server 630 will compensate retailers based on a volume of server 630 based revenue influenced by each of the retailers. The retailers can influence the server 630 based revenue by driving downloads of the consumer application by providing signage in retail facility, by direct mail and by beacon prompting of consumers while they are in the retail facility. Further, the retailers can influence their revenue by integrating POS systems 112 within their retail facilities (e.g., each retail facility may include several POS systems 112, such that a combination of all participating retailers results in the use of numerous, in the order to hundreds to many thousands, POS systems 112) to provide UPC purchase history and accept coupons from the server 630 and by enabling automatic alerts for consumers in the consumer application through the placement of beacons.

Additionally, in an implementation, the server 630 will track metrics associated with each influence discussed above so that the server 630 can perform an attribution process of assigning a monetary value for each activity/influence that will be paid to the retailer.

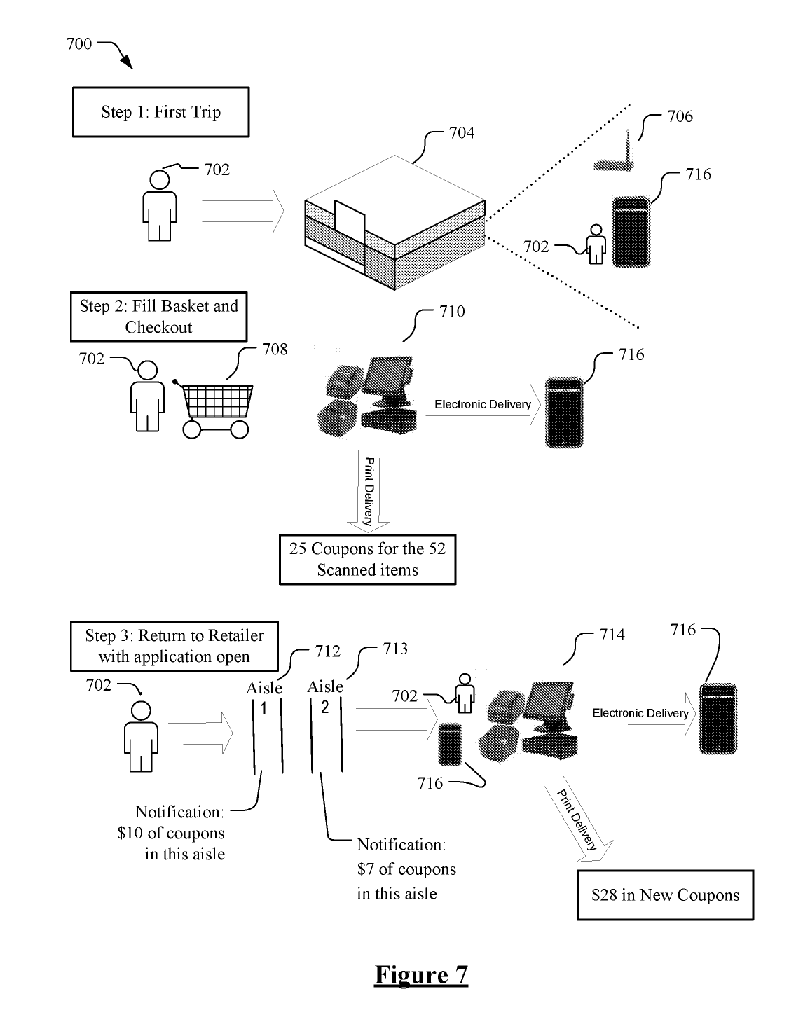

FIG. 7 illustrates one implementation of a process cycle for a consumer.

Referring to FIG. 7 an implementation of a process cycle 700 for a consumer is illustrated and is broken down into three steps.

The first step (e.g., “first trip”) in the process cycle 700 can occur in a variety of places. In this implementation, a consumer 702 enters a retailer 704, where the consumer 702 encounters an NFC device 706 (e.g., the NFC device 606 of FIG. 6) and where the consumer 702 is provided the opportunity to download an application (e.g., a 12 Digit Media application) onto a portable device 716, such as a tablet or smartphone. Alternatively, the consumer 702 may have previously downloaded the application at the retailer 704 or another location, such as the consumer's residence, place of work, by using, for example, an online application store.

After downloading and installing the application onto the portable device 716, the consumer 702 is provided the opportunity to register with the server 630 (e.g., the 12 Digit Media service), as illustrated in FIG. 6, using a unique identifier and password combination. This unique identifier and password combination can be used to protect against fraud by ensuring that only the intended consumer is receiving the coupons. The consumer 702 is also provided the opportunity to contribute data to the system 600, as illustrated in FIG. 6, such age, income bracket, zip code, etc. to better assist the system 600 in proving coupons to the consumer 702.

In the second step (e.g., “fill basket and checkout”), the consumer 702 then collects items for purchase 708 (e.g., 52 items) and proceeds to a POS terminal 710 to have the items for purchase 708 scanned. These scanned items for purchase 708 (e.g., UPC scan data) as well as consumer data (e.g., consumer identification information, consumer loyalty card information, etc.) and other data, such as retailer related information, etc. can be identified as shopping cart data, all of which can be transmitted from the POS terminal 710 and/or the retail server 608 to the server 630. In one implementation, the POS terminal 710, the retail server 608, as illustrated in FIG. 6, or other server related to a selling cycle of the items for purchase 708 notifies the server 630 of the scanned items for purchase 708 that were just purchased by the consumer 702, while, for example, the consumer 702 is at the POS terminal 710 (e.g., this is performed in real time while the consumer 702 is at the POS terminal 710). In this example, 25 of the items purchased by the consumer are products for which UPCs have been added to one or more manufacturers campaigns based on, for example, winning bids of the one or more manufacturers, and which are stored in the campaign data server/database 648, as illustrated in FIG. 6. In an implementation, these winning bids can be based on, the scanned items for purchase 708 (e.g., currently scanned UPCs) and based on historically scanned UPCs (e.g., previously purchased items). For example, a winning bid can be based on an item that the consumer 702 purchased in a previous day, week or month. This historical information (e.g., the historically scanned UPCs) can be stored, for example, in the UPC purchase history server/database 610 and/or 650. The coupon distribution engine 640, of the system 600 illustrated in FIG. 6, then transmits 25 coupons, for a total saving of $28.00 as defined in the campaign data server/database 648 to the consumer 702 electronically to the application on the portable device 716 of the consumer 702 or in a printed version, and records the distribution in the coupon/UPC history database 646.

In the third step (e.g., “return visit”), on a subsequent trip to the retailer 704, the consumer 702 now has the coupons they received as a result of their first visit available in an electronic format via the application or in a printed format. In an implementation, as the consumer 702 visits a specific aisle 712 or 713, the application of the portable device 716 can notify the consumer 702 that the consumer 702 has $10.00 worth of coupons available for purchasing items in aisle 1 712 and $7.00 worth of coupons available for purchasing items in aisle 2 713. These notifications may be provided at any point while the consumer 702 has the application of the portable device 716 open or they may be provided within the application of the portable device 716 as the consumer 702 is in the corresponding aisle by using strategically placed beacons.

In one example, if the consumer 702 chooses to purchase the item for which they have a coupon, then the consumer 702 would display a coded object, such as a QR Code, a stock keeping unit code (SKU) or UPC, to a POS terminal 714 located in a checkout area using the application of the portable device 716 or the printed format. The POS terminal 714 can then reconcile the coupon with the coupon clearance engine 642, as illustrated in FIG. 6.

After the redemption of the coupons, the server 630 can record the event in the user profile database 634, as illustrated in FIG. 6. In another implementation, the POS terminal 710 can be configured to retrieve the coupon(s) automatically from the server 630. The purchases made on this subsequent visit to the retailer 704 will electronically gather more coupons for the consumer 702. In another implementation the coupon(s) can be automatically added to, for example, a loyalty card of the consumer 702 and the savings would occur at the POS terminal 710 at a subsequent visit of the consumer 702. In this example implementation illustrated in FIG. 7, the consumer 702 redeems $14.00 of the $28.00 worth of coupons that were made available as a result of step 2; and the consumer 702 receives another $28 worth of new coupons to use on the next visit.

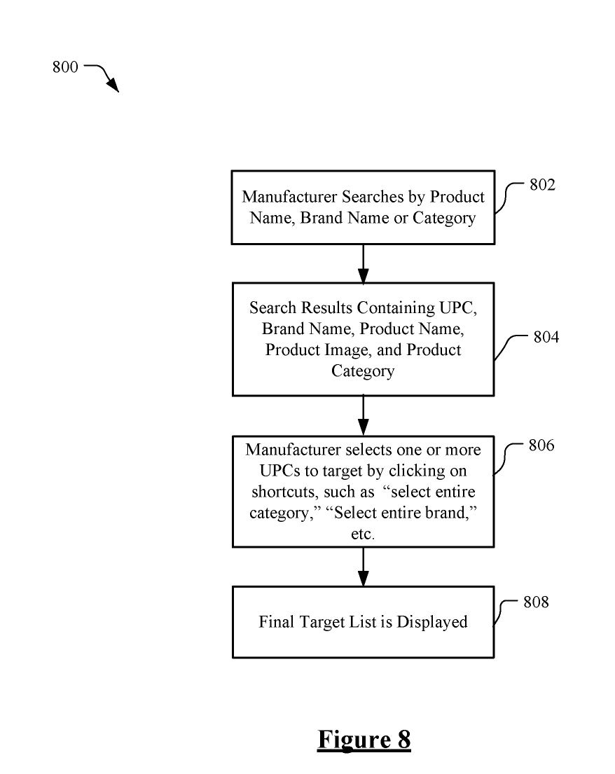

FIG. 8 illustrates a flowchart describing a UPC targeting process by a manufacturer, according to an embodiment of the present disclosure.

Referring to FIG. 8, a flowchart 800 including various operations is illustrated to describe a UPC targeting process (e.g., an (ongoing) online bidding process) by a manufacturer. Specifically, in operation 802 the manufacturer searches the UPC library database 632, as illustrated in FIG. 6, by product name, brand name, category, UPC, etc. The manufacturer can create customized categories, browse the results and refine brands based on multiple attributes.

Results of the search by the manufacture are displayed/provided to the manufacturer in operation 804. Depending on variables used to perform the search, results may include UPC(s), brand name(s), product name(s) and product category(ies) accumulated, for example, in a list.

In operation 806, the manufacturer is provided the opportunity to select one or more of the UPCs included in the list as targets for a campaign. A single UPC may be selected to target coupons at a UPC granular level or multiple UPCs may be selected to target coupons based on a group of UPCs. Rather than selecting each UPC, the manufacturer may be provided with shortcuts to select an entire category, select an entire brand, etc.

After the manufacturer selects the one or more UPCs in operation 806, a final target list is then presented to the manufacturer for use in subsequent phases of the targeting process in operation 808.

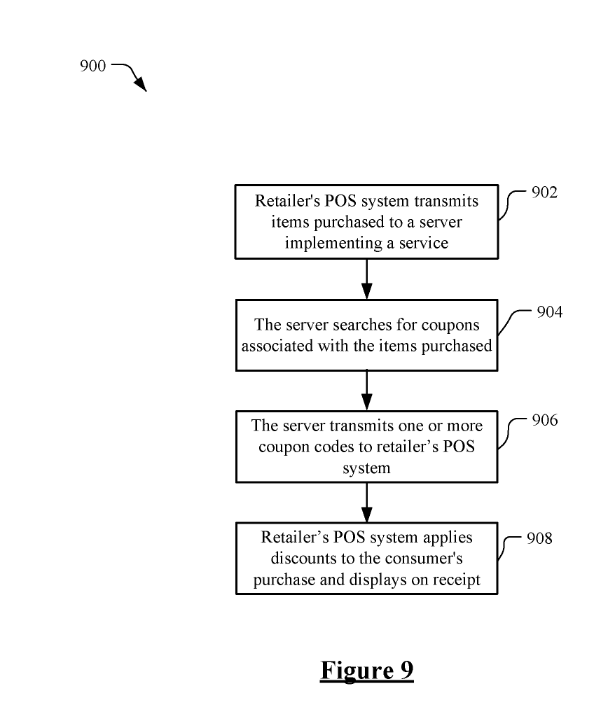

FIG. 9 illustrates one implementation of a coupon redemption process by a retailer, according to an embodiment of the present disclosure.

Referring to FIG. 9, a flowchart 900 including various operations is illustrated to describe a redemption process performed by a retailer. Specifically, in operation 902 the retailer may utilize a POS system to transmit a list of items purchased by a consumer to, for example, the server 630, as illustrated in FIG. 6, for implementing a service.

Next, in operation 904 the server 630 searches for the coupons that have been associated with the consumer based on, for example, previously collected shopping cart data of the consumer and coupons that were issued for the items purchased based on various bids from manufacturers.

Based on the results of the search performed in operation 904, the coupon clearance engine 642, as illustrated in FIG. 6, transmits one or more coupon codes to the retailer's POS system and then records their use in operation 906. Accordingly, in this implementation, the server 630 essentially keeps track of the coupons that have been provided to the consumer and then provides the appropriate coupons to the retailer's POS system while the consumer is completing their purchase.

In operation 908, the retailer's POS system applies the discounts to the consumer's purchase and displays the discounts on a purchase receipt. A history of the above-described redemption can also be stored for the consumer for issues such as reporting and future market research.

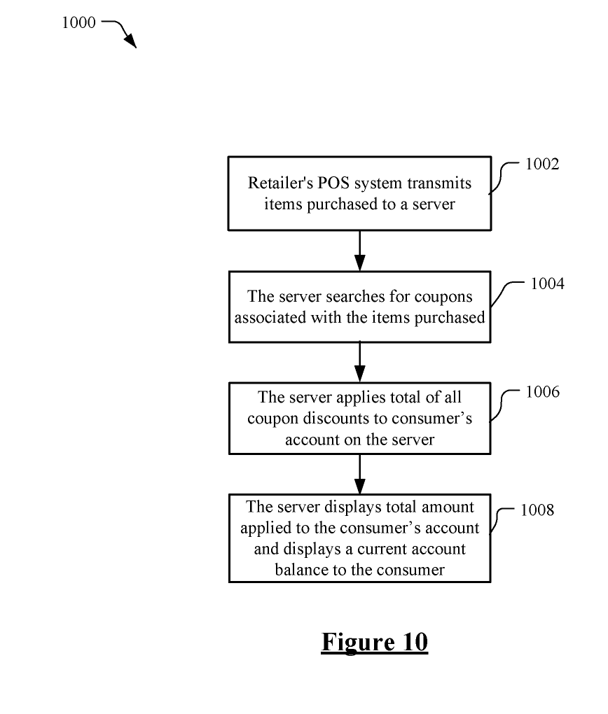

FIG. 10 illustrates a process of adding discounts to a consumer's account, according to an embodiment of the present disclosure.

Referring to FIG. 10, a flowchart 1000 including various operations is illustrated to describe a process of adding discounts to a consumer's account. Specifically, in operation 1002 a retailer may utilize a POS system to transmit a list of items purchased by a consumer to, for example, the server 630, as illustrated in FIG. 6, for implementing a service. This list of items may be identified as shopping cart data. The shopping cart data may also include, for example, consumer data (e.g., consumer identification information, consumer loyalty card information, etc.).

Next, in operation 1004 the server 630 searches for the coupons that are associated with the consumer based on, for example, the shopping cart data, and that are to be issued to the consumer for the items purchased based on various bids from manufacturers.

Based on the results of the search performed in operation 1004, the server 630 applies the total of all coupon discounts to a consumer's account on the server 630 in operation 1006.

In operation 1008 the server 630 displays a total amount applied to the consumer's account on the server 630 and displays a current account balance to the consumer.

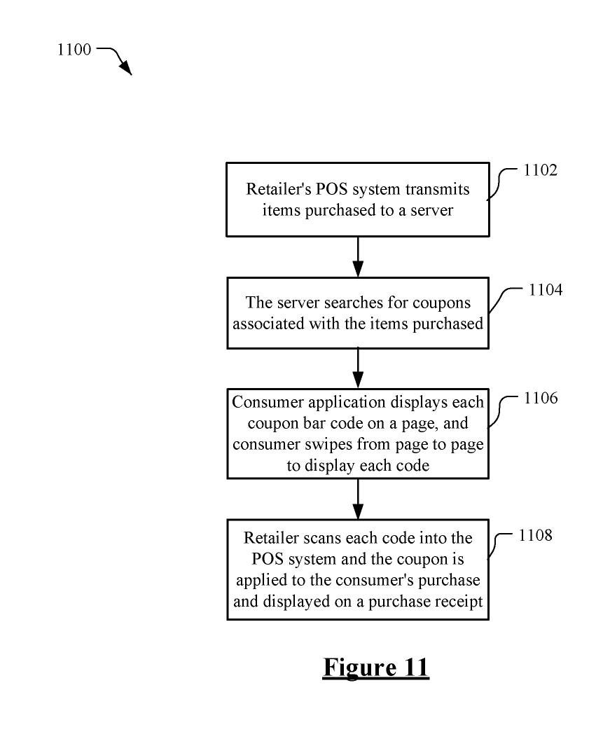

FIG. 11 illustrates one implementation of a process for a retailer to scan coupon codes represented by multiple one-dimensional bar codes, according to an embodiment of the present disclosure.

Referring to FIG. 11, a flowchart 1100 including various operations is illustrated to describe a process for a retailer to scan coupon codes represented by multiple one-dimensional bar codes. Specifically, in operation 1102 a retailer may utilize a POS system to transmit a list of items purchased by a consumer to, for example, the server 630, as illustrated in FIG. 6, for implementing a service.

Next, in operation 1104 the server 630 searches for the coupons that are associated with the consumer based on, for example, shopping cart data including a list of UPC items, consumer identification, etc., and that are to be issued to the consumer for the items purchased based on various bids from manufacturers.

Based on the results of the search performed in operation 1104, a consumer application associated with the server 630 displays each coupon bar code on a page and allows the consumer to swipe from page to page (e.g., to swipe from right-to-left or left-to-right using a finger, pointing device, controller, etc. to change a page that is displayed) to display each coupon bar code in operation 1106.

In operation 1108, as the consumer swipes from page to page, the retailer scans each code in to the POS system, such that the coupon is applied to the consumer's purchase and displays the discounts on a purchase receipt.

In operation 1108 the server 630 displays a total amount applied to the consumer's account on the server 630 and displays a current account balance to the consumer.

The process illustrated in FIG. 11 can be modified to recognize other codes besides one-dimensional bar codes.

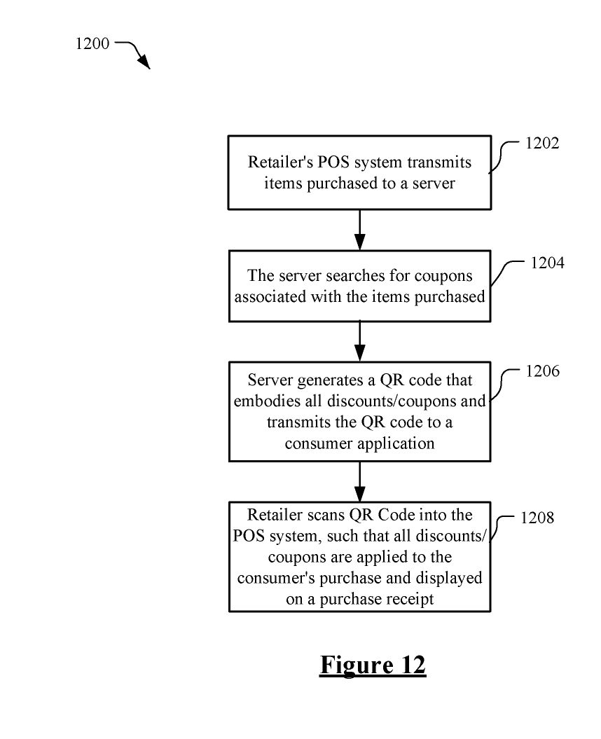

FIG. 12 illustrates one implementation of a process for a retailer to scan a batch of coupon codes represented by a QR code, according to an embodiment of the present disclosure.

Referring to FIG. 12, a flowchart 1200 including various operations is illustrated to describe a process of a retailer scanning a batch of coupon codes represented by a single QR code. Specifically, in operation 1202 a retailer may utilize a POS system to transmit a list of items purchased by a consumer to, for example, the server 630, as illustrated in FIG. 6, for implementing a service. This list of items may be identified as shopping cart data. The shopping cart data may also include, for example, consumer data (e.g., consumer identification information, consumer loyalty card information, etc.).

Next, in operation 1204 the server 630 searches for the coupons that are associated with the consumer based on, for example, the shopping cart data, and that are to be issued for the items purchased based on various bids from manufacturers.

Based on the results of the search performed in operation 1204, the server generates a QR code that embodies all coupons/discounts and transmits the QR code to a consumer application associated with the server 630 in operation 1206. Alternatively, rather than being a QR code, the code generated by the server may be a PDF417 code, a GS1 Databar code, a DataMatrix code, or any other two dimensional code

In operation 1208, the retailer scans the QR code, as provided by the consumer into the POS system.

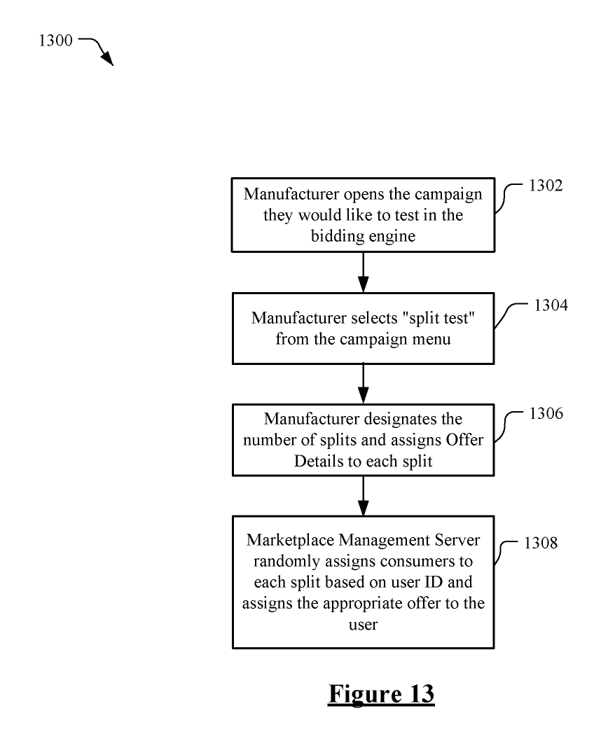

FIG. 13 illustrates a process of an A/B test configuration, according to an embodiment of the present disclosure.

Referring to FIG. 13, a flowchart 1300 including various operations is illustrated to describe a process of an A/B test configuration, such as, for example a split test (e.g., split audition) or even a multivariate test (e.g., multivariate audition). Specifically, in operation 1302 a manufacturer opens a campaign to be tested (e.g., auditioned) in the bidding engine 638, as illustrated in FIG. 6.

Next, in operation 1304, the manufacture can select “split test” from a campaign menu provided by the bidding engine 638.

Then, in operation 1306, the manufacturer can designate a number of splits and assign coupon details to each split.

In operation 1308, a marketplace management server 636, as illustrated in FIG. 6, randomly assigns consumers to each split based on their user ID and assigns the appropriate coupon to the user.

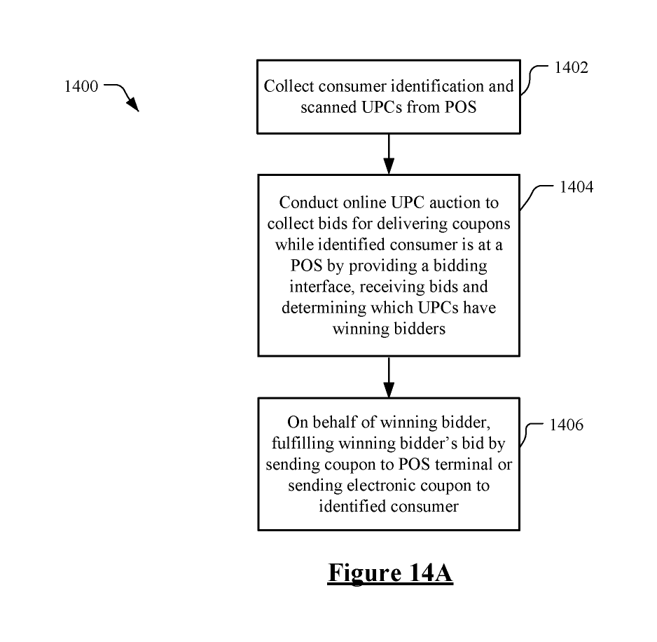

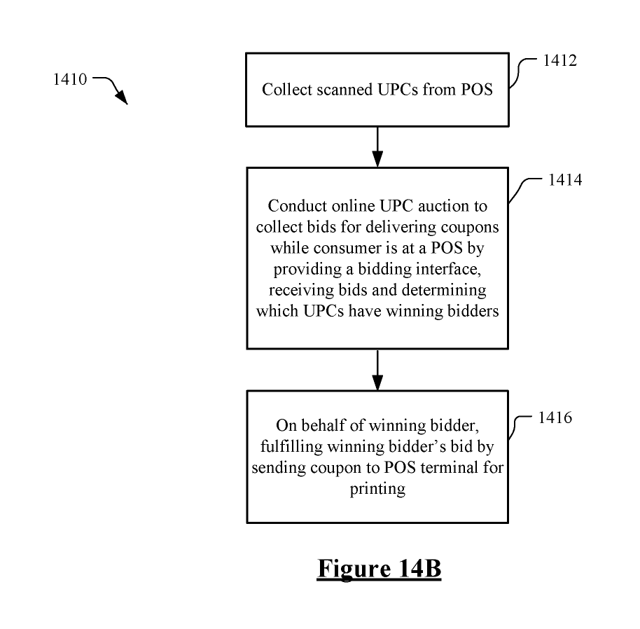

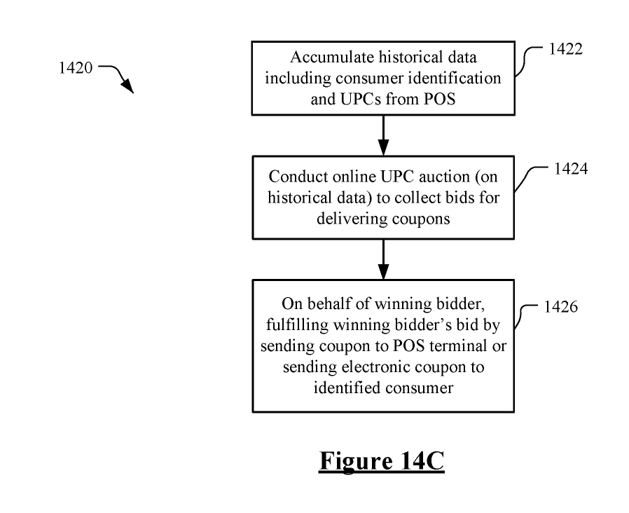

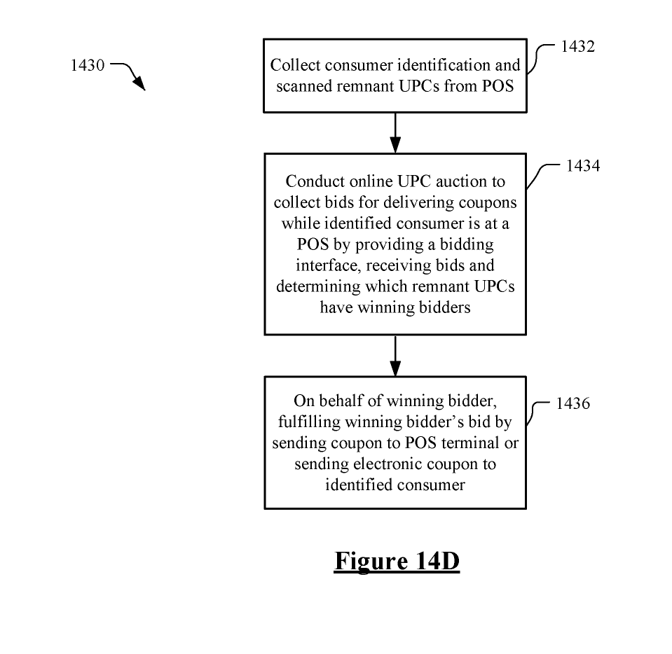

FIGS. 14A, 14B, 14C and 14D illustrate various implementations of providing one or more targeted coupons to a consumer, according to various embodiments of the present disclosure.

Referring to FIG. 14A, a flowchart 1400 including various operations is illustrated to describe a process of providing one or more target coupons to a consumer. This process of providing the coupons to the consumer is performed using consumer identification information (e.g., loyalty card information) and UPC information that is scanned while the consumer is currently at a POS terminal of a physical store.

In operation 1402 the process collects a consumer's identification and scanned UPCs from the POS. Specifically, operation 1402 may include, for example, collecting shopping cart data from numerous POS terminals (e.g., POS terminal 612, as illustrated in FIG. 6) in physical stores, the shopping cart data identifying the consumer (e.g., consumer 620, as illustrated in FIG. 6) using a unique consumer identification and identifying one or more UPCs scanned while the identified consumer is present at one of the POS terminals.

In operation 1404 the process conducts an online UPC auction (e.g., server 630, as illustrated in FIG. 6, conducts the auction) to collect bids for delivering coupons while the identified consumer is at the POS by providing a bidding interface, receiving bids and determining which UPCs have winning bidders. More specifically, operation 1404 may include, for example, conducting an online UPC auction to collect bids, by UPC or a group of UPCs, for delivery of coupons to the identified consumer triggered by scanning of a UPC or UPCs in the physical stores, in which winning bids, if any, are determined as of the time the identified consumer is present at the POS terminal.

Referring to operation 1404, in an implementation, a current winning bidder for a particular UPC is entitled to send their coupon to the POS terminal for printing, to send a message to the POS terminal for printing that refers to an electronic coupon delivery, and/or send an electronic coupon to the identified consumer, and the online UPC auction accepts bids and withdrawal of bids from bidding participants using bidding terminals (e.g., marketing computer 604 and campaign engine 602, as illustrated in FIG. 6), and determines the current winning bidder from among the bidding participants on an ongoing basis by performing the following:

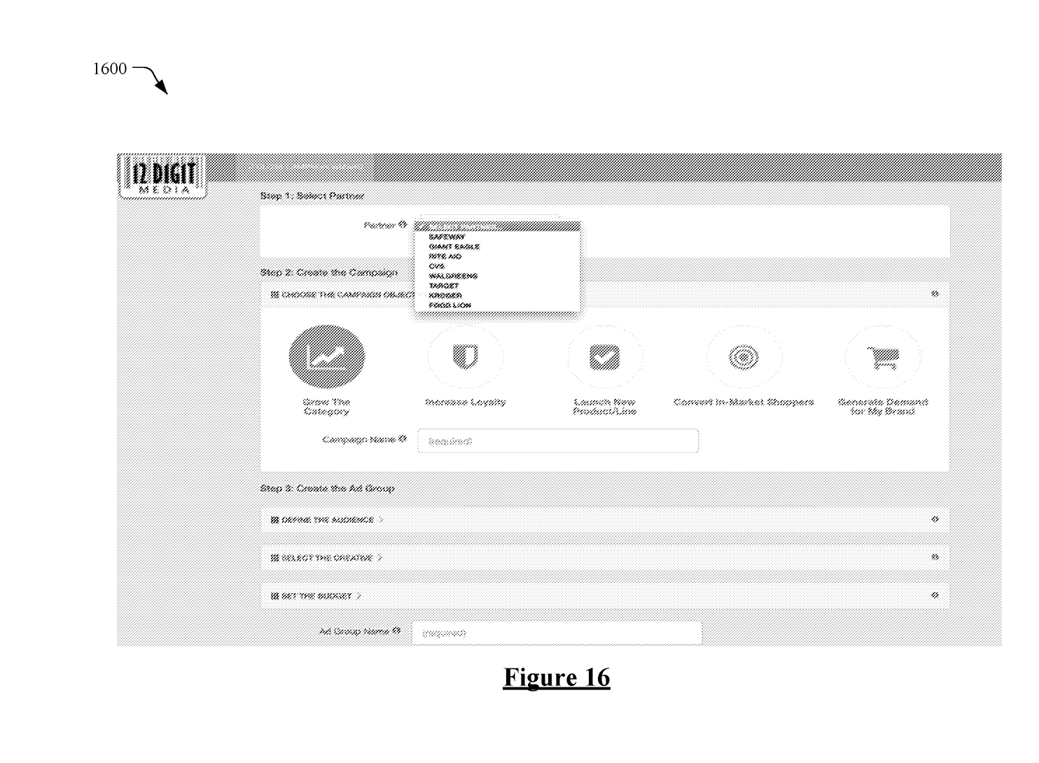

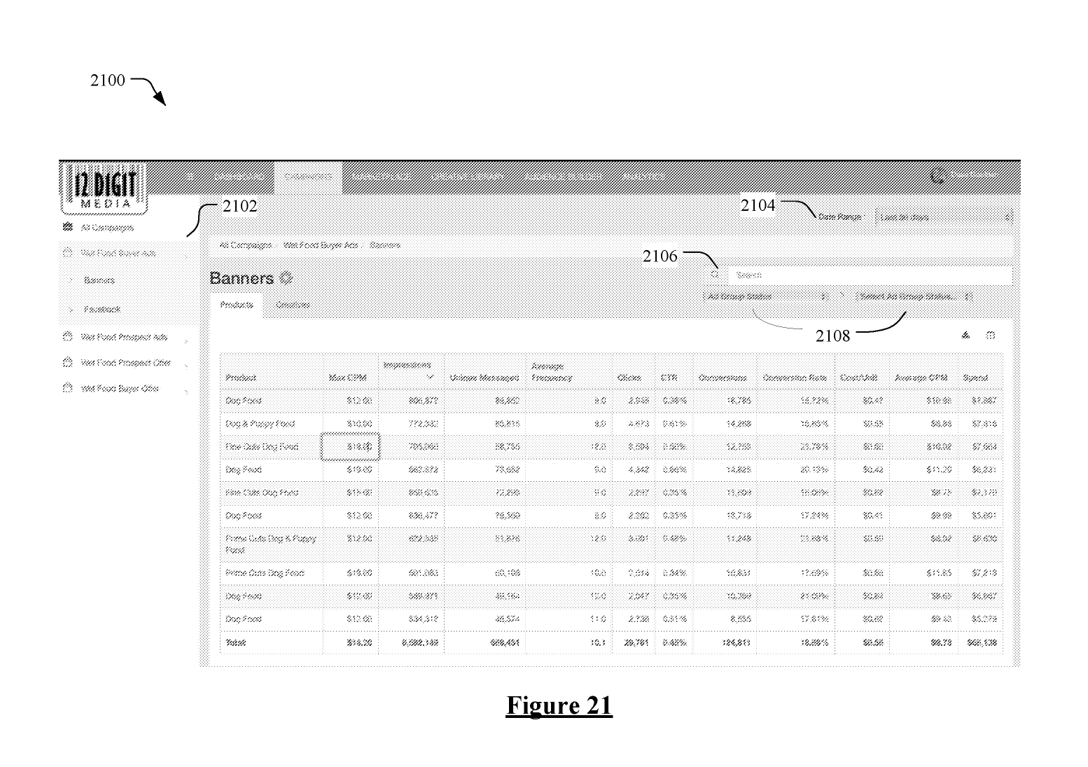

Providing a bidding interface (e.g., screenshots 1600, 1700, 1800 and 1900, as illustrated in FIGS. 16-19) to the bidding terminals that identifies the UPCs that are available through the online UPC auction; receiving from the bidding interface, bids on selected UPCs of the available UPCs, as well as, for example, bid effective dates, and coupon descriptions that include coupon values (e.g., screenshots 1600, 1700, 1800 and 1900); tracking, for the selected UPCs, bid scores based at least in part on the bids on the selected UPCs (e.g., screenshot 2100, as illustrated in FIG. 21); and while the identified consumer remains present at the POS terminal, using at least the bid scores to determine a current best bid for a particular UPC and determining, among the one or more UPCs identified by the shopping cart data, which UPCs have winning bidders.

In operation 1406 the process includes, on behalf of winning bidder and, for example, responsive to an election by the winning bidder, fulfilling the winning bidder's bid by sending a coupon to the POS terminal or sending an electronic coupon to the identified consumer. Specifically, operation 1406 may include, for example, on behalf of a winning bidder and responsive to an election by the winning bidder, fulfilling the winning bidder's bid by, at least one of, sending the coupon to the POS terminal for printing, sending the message to the POS terminal for printing, and sending the electronic coupon to the identified consumer (e.g., “Step 2” and “Step 3,” as illustrated in FIG. 7).

Referring to FIG. 14B, a flowchart 1410 including various operations is illustrated to describe a process of providing one or more target coupons to a consumer. This process of providing the coupons to the consumer is performed using UPC information that is scanned while the consumer is currently at a POS terminal of a physical store.

In operation 1412 the process collects scanned UPCs from the POS. Specifically, operation 1412 may include, for example, collecting one or more UPCs scanned while the consumer is present at one POS terminal of numerous POS terminals in physical stores (e.g., POS terminal 612 and consumer 620, as illustrated in FIG. 6).

In operation 1414 the process conducts an online UPC auction (e.g., server 630, as illustrated in FIG. 6, conducts the auction) to collect bids for delivering coupons while the consumer is at the POS by providing a bidding interface, receiving bids and determining which UPCs have winning bidders. More specifically, operation 1414 may include, for example, conducting an online UPC auction to collect bids, by UPC or a group of UPCs, for delivery of coupons to the consumer triggered by scanning of a UPC or UPCs in the physical stores, in which winning bids, if any, are determined as of the time the consumer is present at the POS terminal.

Referring to operation 1414, in an implementation, a current winning bidder for a particular UPC is entitled to send their coupon to the POS terminal for printing, and the online UPC auction accepts bids and withdrawal of bids from bidding participants using bidding terminals (e.g., marketing computer 604 and campaign engine 602, as illustrated in FIG. 6), and determines the current winning bidder from among the bidding participants on an ongoing basis by performing the following:

Providing a bidding interface (e.g., screenshots 1600, 1700, 1800 and 1900, as illustrated in FIGS. 16-19) to the bidding terminals that identifies the UPCs that are available through the online UPC auction; receiving from the bidding interface, bids on selected UPCs of the available UPCs, as well as, for example, bid effective dates, and coupon descriptions that include coupon values (e.g., screenshots 1600, 1700, 1800 and 1900); tracking, for the selected UPCs, bid scores based at least in part on the bids on the selected UPCs (e.g., screenshot 2100, as illustrated in FIG. 21); and while the consumer remains present at the POS terminal, using at least the bid scores to determine a current best bid for a particular UPC and determining, among the one or more collected UPCs, which UPCs have winning bidders.

In operation 1416 the process includes, on behalf of winning bidder and, for example, responsive to an election by the winning bidder, fulfilling winning bidder's bid by sending a coupon to the POS terminal for printing. Specifically, operation 1416 may include, for example, on behalf of a winning bidder and responsive to an election by the winning bidder, fulfilling the winning bidder's bid by sending the coupon to the POS terminal for printing.

Referring to FIG. 14C, a flowchart 1420 including various operations is illustrated to describe a process of providing one or more target coupons to a consumer. This process of providing the coupons to the consumer is performed using historical data including UPC information that is scanned while the consumer is currently at a POS terminal of a physical store and UPC data that has been collected and stored based on previous purchases. Specifically, this historical data may include past (e.g., historical) and present purchase information associated with the consumer. Accordingly, online auctions, as discussed below, can be performed on past and present/current UPC scan information.

In operation 1422 the process accumulates historical data including consumer identification and scanned UPCs from the POS. Specifically, operation 1422 may include, for example, accumulating, as historical data, shopping cart data from numerous POS terminals in physical stores, the shopping cart data identifying a consumer using a unique consumer identification and identifying one or more UPCs scanned while the identified consumer is present at one of the POS terminals (e.g., POS terminal 612 and consumer 620, as illustrated in FIG. 6).

In operation 1424 the process conducts an online UPC auction on, for example, the historical data (e.g., server 630, as illustrated in FIG. 6, conducts the auction) to collect bids for delivering coupons. More specifically, operation 1424 may include, for example, conducting an online UPC auction to collect bids, by UPC or a group of UPCs, for delivery of coupons to the identified consumer triggered by identification of the consumer at the POS terminal, in combination with the historical data that identifies UPCs of goods purchased by the identified consumer in the physical stores, in which winning bids, if any, are determined as of the time the identified consumer is present at the POS terminal.

Referring to operation 1424, in an implementation, the online UPC auction is conducted using the one or more UPCs identified by the historical data collected in a historical period of at least one week and associated with the unique consumer identification of the identified consumer, a current winning bidder for a particular UPC is entitled to send their coupon to the POS terminal for printing, to send a message to the POS terminal for printing that refers to an electronic coupon delivery, and/or send an electronic coupon to the identified consumer, and the online UPC auction accepts bids and withdrawal of bids from bidding participants using bidding terminals (e.g., marketing computer 604 and campaign engine 602, as illustrated in FIG. 6), and determines the current winning bidder from among the bidding participants on an ongoing basis by performing the following:

Receiving from a bidding interface, bids on selected UPCs of UPCs that are available UPCs through the online UPC auction, as well as, for example, bid effective dates, and coupon descriptions that include coupon values, the selected UPCs being included in the historical data; tracking, for the selected UPCs, bid scores based at least in part on the bids on the selected UPCs; and while the identified consumer remains present at the POS terminal, using at least the bid scores to determine a current best bid for a particular UPC and determining, among the one or more UPCs identified by the historical data, which UPCs have winning bidders.

In operation 1426 the process includes, on behalf of winning bidder and, for example, responsive to an election by the winning bidder, fulfilling the winning bidder's bid by sending a coupon to the POS terminal or sending an electronic coupon to the identified consumer. Specifically, operation 1426 may include, for example, on behalf of a winning bidder and responsive to an election by the winning bidder, fulfilling the winning bidder's bid by, at least one of, sending the coupon to the POS terminal for printing, sending the message to the POS terminal for printing, and sending the electronic coupon to the identified consumer (e.g., “Step 2” and “Step 3,” as illustrated in FIG. 7).

Referring to FIG. 14D, a flowchart 1430 including various operations is illustrated to describe a process of providing one or more target coupons to a consumer. This process of providing the coupons to the consumer is performed using consumer identification information (e.g., loyalty card information) and remnant UPC information that is scanned while the consumer is currently at a POS terminal of a physical store. In another implementation, this process of flowchart 1430 can be performed without using the consumer identification information, but still using the remnant UPC information. In other words, the consumer may not be specifically identified, but the remnant UPC information can still be used, as described in the following operations (e.g., the auction and fulfillment process regarding the remnant UPCs can be performed without having specifically identified the consumer and or the consumer's loyalty card information).

In operation 1432 the process collects a consumer's identification and scanned remnant UPCs from the POS. Specifically, operation 1432 may include, for example, collecting shopping cart data from numerous POS terminals (e.g., POS terminal 612, as illustrated in FIG. 6) in physical stores, the shopping cart data identifying the consumer (e.g., consumer 620, as illustrated in FIG. 6) using a unique consumer identification and identifying one or more remnant UPCs scanned while the identified consumer is present at one of the POS terminals.

In operation 1434 the process conducts an online UPC auction (e.g., server 630, as illustrated in FIG. 6, conducts the auction) to collect bids for delivering coupons while the identified consumer is at the POS by providing a bidding interface, receiving bids and determining which remnant UPCs have winning bidders. More specifically, operation 1434 may include, for example, conducting an online UPC auction to collect bids, by UPC or a group of UPCs, for delivery of coupons to the identified consumer triggered by scanning of a remnant UPC or remnant UPCs in the physical stores, in which winning bids, if any, are determined as of the time the identified consumer is present at the POS terminal.

Referring to operation 1434, in an implementation, the remnant UPC or the remnant UPCs are a portion of available UPCs that have not been exclusively sold through a pre-auction channel, a current winning bidder for a particular remnant UPC is entitled to send their coupon to the POS terminal for printing, to send a message to the POS terminal for printing that refers to an electronic coupon delivery, and/or send an electronic coupon to the identified consumer, and the online UPC auction accepts bids and withdrawal of bids from bidding participants using bidding terminals (e.g., marketing computer 604 and campaign engine 602, as illustrated in FIG. 6), and determines the current winning bidder from among the bidding participants on an ongoing basis by performing the following:

Providing a bidding interface (e.g., screenshots 1600, 1700, 1800 and 1900, as illustrated in FIGS. 16-19) to the bidding terminals that identifies the remnant UPCs that are available through the online UPC auction; receiving from the bidding interface, bids on selected remnant UPCs of the available remnant UPCs, as well as, for example, bid effective dates, and coupon descriptions that include coupon values (e.g., screenshots 1600, 1700, 1800 and 1900); tracking, for the selected remnant UPCs, bid scores based at least in part on the bids on the selected remnant UPCs (e.g., screenshot 2100, as illustrated in FIG. 21); and while the identified consumer remains present at the POS terminal, using at least the bid scores to determine a current best bid for a particular remnant UPC and determining, among the one or more remnant UPCs identified by the shopping cart data, which remnant UPCs have winning bidders.

In operation 1436 the process includes, on behalf of winning bidder and, for example, responsive to an election by the winning bidder, fulfilling the winning bidder's bid by sending a coupon to the POS terminal or sending an electronic coupon to the identified consumer. Specifically, operation 1436 may include, for example, on behalf of a winning bidder and responsive to an election by the winning bidder, fulfilling the winning bidder's bid by, at least one of, sending the coupon to the POS terminal for printing, sending the message to the POS terminal for printing, and sending the electronic coupon to the identified consumer (e.g., “Step 2” and “Step 3,” as illustrated in FIG. 7)

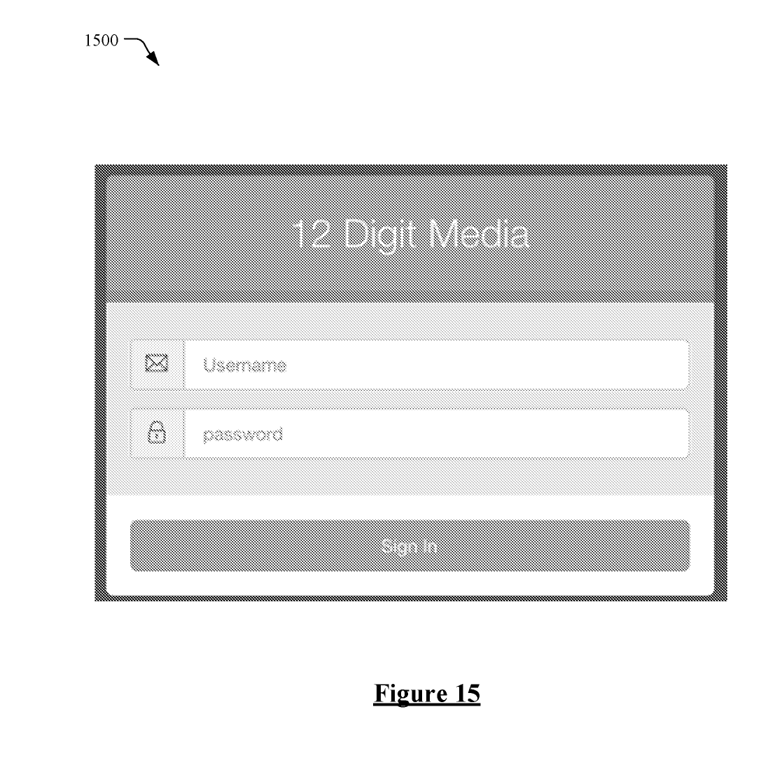

FIG. 15 illustrates an implementation of a login screen of an online exchange, according to an embodiment of the present disclosure.

Referring to FIG. 15, a login screen 1500 is presented to a user of the system 600, as illustrated in FIG. 6. Specifically, FIG. 15 illustrates that the login screen 1500 allows a user (e.g., a manufacturer, a brand manager representing an interest of a manufacturer, a retailer that sell products, etc.) to log into various aspects of an online exchange (e.g., marketplace, online auction, etc.) provided by the system 600 by entering a previously designated username and password and selecting “Sign In.” In an implementation, this online exchange is provided by 12 Digit Media. Various aspects of this online exchange, beyond the login screen 1500 are illustrated in FIGS. 16-23.

FIG. 16 illustrates an implementation of a campaign wizard of an online exchange for selecting a (retail) partner and choosing a campaign objective (e.g., a group of objectives) of a specific campaign, according to an embodiment of the present disclosure.

Referring to FIG. 16, a screenshot 1600 of a campaign wizard implemented by an online exchange (e.g., marketplace, online auction, etc.) is illustrated. As illustrated, in step 1 the campaign wizard allows a user (e.g., a manufacturer, BM, etc.) to select a partner (e.g., retailer) to which a coupon campaign will be directed. For example, FIG. 16 illustrates example partners, such as Safeway®, Giant Eagle®, Rite Aid®, CVS®, Walgreens®, Target®, Kroger®, Food Lion®, etc.

As illustrated in step 2, after the user selects their intended partner, the campaign wizard 1600 allows the user to select a campaign objective and to add a mandatory campaign name. Pre-loaded campaign objectives provided by the campaign wizard 1600 may include, “Grow The Category,” “Increase Loyalty,” “Launch New Product/Line,” “Convert In-Market Shoppers,” and “Generate Demand for My Brand.” Each of these campaign objectives will utilize different algorithms in order to better assist the user in the development of their campaign. For example, the objective “Increase Loyalty” may assist the user in targeting coupons that will reward consumers that have been loyal to their brand, based on previous purchase data, etc. Accordingly, in an implementation, the user can bid, using historical data, on currently scanned UPCs and on historically scanned UPCs (e.g., UPCs scanned by a consumer on a previous visit), wherein this historic data can be utilized for bidding purposes for certain historical time periods, such as, for example, all UPCs scanned within the last week. On the other hand, the objective “Grow the Category” may assist the user to find consumers who through targeted coupons will potentially grow a specific category of the user.

This campaign wizard provides a simple interface allowing the user to develop an objective-based campaign that matches the user's particular needs. Further, this interface provided by the online exchange will always be available for the user, so that the user can develop their strategy for targeting coupons without time constraints, etc.

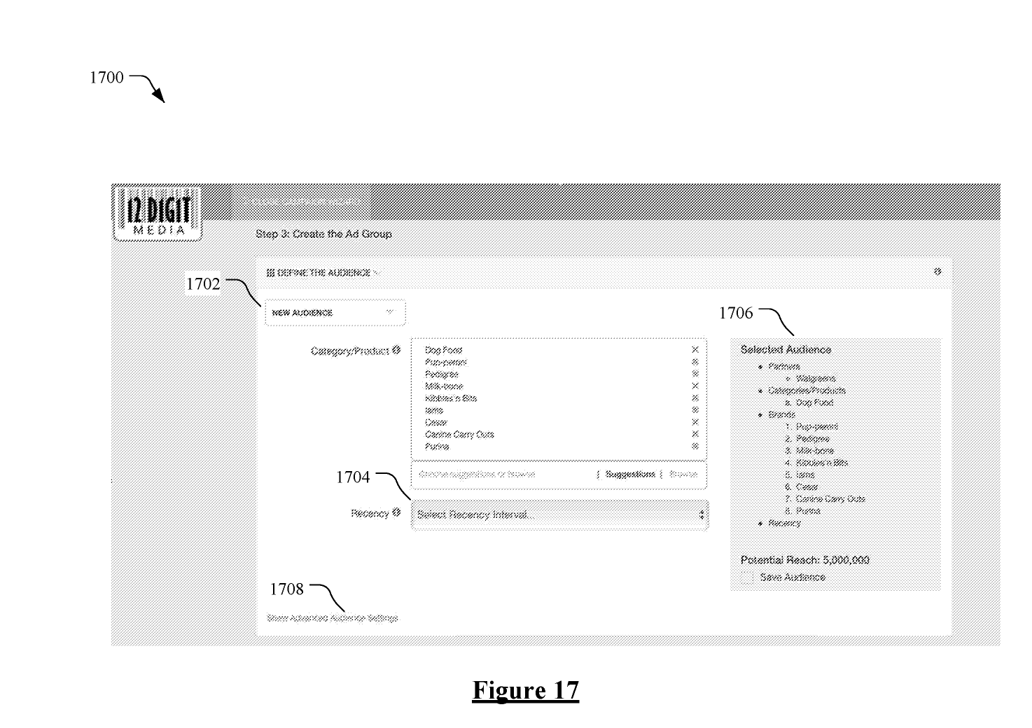

As illustrated in step 3, after the user selects their campaign objective and provides a name for their campaign, the user is able to create an ad (e.g., coupon) group by defining (e.g., pre-defining) an audience, selecting the creative aspects of their campaign and setting a budget for their campaign. The campaign wizard also requires the user to identify a name for their ad (e.g., coupon) group. The process of defining the audience is described below with reference to FIG. 17.

This screenshot 1600 and the information illustrated therein are merely examples and should not be limited by the data and/or options illustrated therein. Additional data and/or options may be provided to the user and/or customized by the user.

FIG. 17 illustrates an implementation of a campaign wizard of an online exchange for defining an audience of a specific campaign, according to an embodiment of the present disclosure.

Referring to FIG. 17, a screenshot 1700 of a campaign wizard implemented by an online exchange (e.g., marketplace, online auction, etc.) is illustrated. As illustrated, the user is provided an opportunity to define a new audience or select a previously defined audience using dropdown menu 1702. If the user decides to define a new audience, the user can select a category/product to target from a list of suggestions provided by the campaign wizard or the user can browse various categories/products to which they would like to target their coupons. Furthermore, the campaign wizard provides a dropdown menu 1704, which allows the user to select a recency interval, which is a timeframe in which a consumer may have purchased a product that falls within the category/product selected by the user. The campaign wizard also provides a summary 1706 of the selected audience which identified selected partners, categories/products, brands and recency interval selected by the user. The summary 1706 may provide information regarding the number of potential consumers that might be reached by the present campaign, and may provide the user the option to save the selected audience.

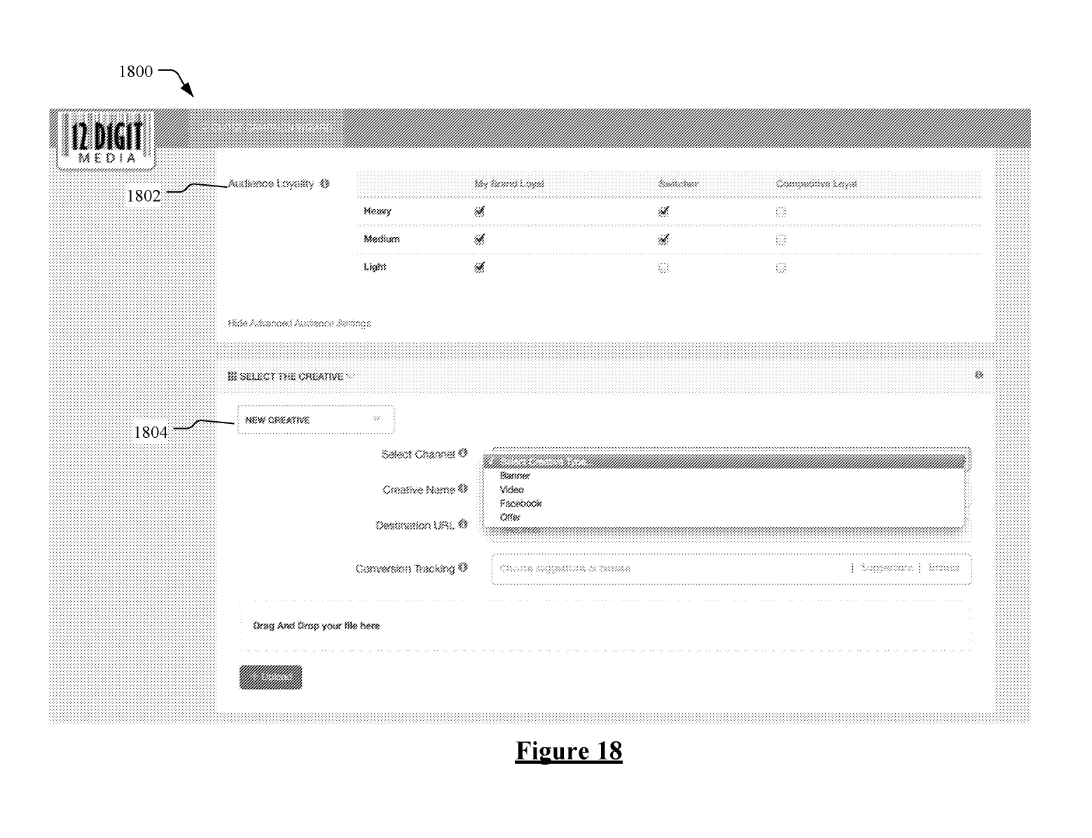

Moreover, the campaign wizard can provide the user with advanced audience setting options 1708 regarding the audience being defined by the user. These advanced settings are discussed below with reference to FIG. 18.

This screenshot 1700 and the information illustrated therein are merely examples and should not be limited by the data and/or options illustrated therein. Additional data and/or options may be provided to the user and/or customized by the user.

FIG. 18 illustrates an implementation of a campaign wizard of an online exchange for defining audience loyalty and selecting a type of coupon to be provided for a specific campaign, according to an embodiment of the present disclosure, according to an embodiment of the present disclosure.

Referring to FIG. 18, a screenshot 1800 of a campaign wizard implemented by an online exchange (e.g., marketplace, online auction, etc.) is illustrated. As illustrated, if the user chooses to view the advanced audience settings, as discussed above with reference to FIG. 17, the user is provided the opportunity to define audience loyalty 1802 (e.g., various characteristics of the audience to be targeted based on their loyalty). For example, the user can select whether to include audience members (e.g., customers/consumers) who have heavy brand loyalty, medium brand loyalty or light brand loyalty. The user can select any or none of heavy, medium and light. Further, as illustrated, the user can select whether to include audience members who are heavy switchers (e.g., consumer who switch brands based on price, availability, etc.), medium switchers or light switchers. Additionally, as illustrated, the user can select whether to include audience members who have heavy loyalty to a competitor, medium loyalty to a competitor or light loyalty to a competitor.

Additionally, as illustrated in FIG. 18, when selecting the creative aspect of the campaign, the user is provided with a dropdown menu 1804 that allows the user to define a new creative or select previously defined creatives. If the user decides to define a new creative, the user will be able to select a channel, such as banner, video, Facebook®, offer, etc. In this implementation, the user will select “offer” in order to create a campaign that provides targeted coupons. Moreover, the user is provided the opportunity to define a name of the new creative, add a destination URL if appropriate, to add conversion tracking based on a suggestion or from browsing a list, and to upload/add a file that includes, for example, the contents of the coupon to be delivered to the consumer.

This screenshot 1800 and the information illustrated therein are merely examples and should not be limited by the data and/or options illustrated therein. Additional data and/or options may be provided to the user and/or customized by the user.

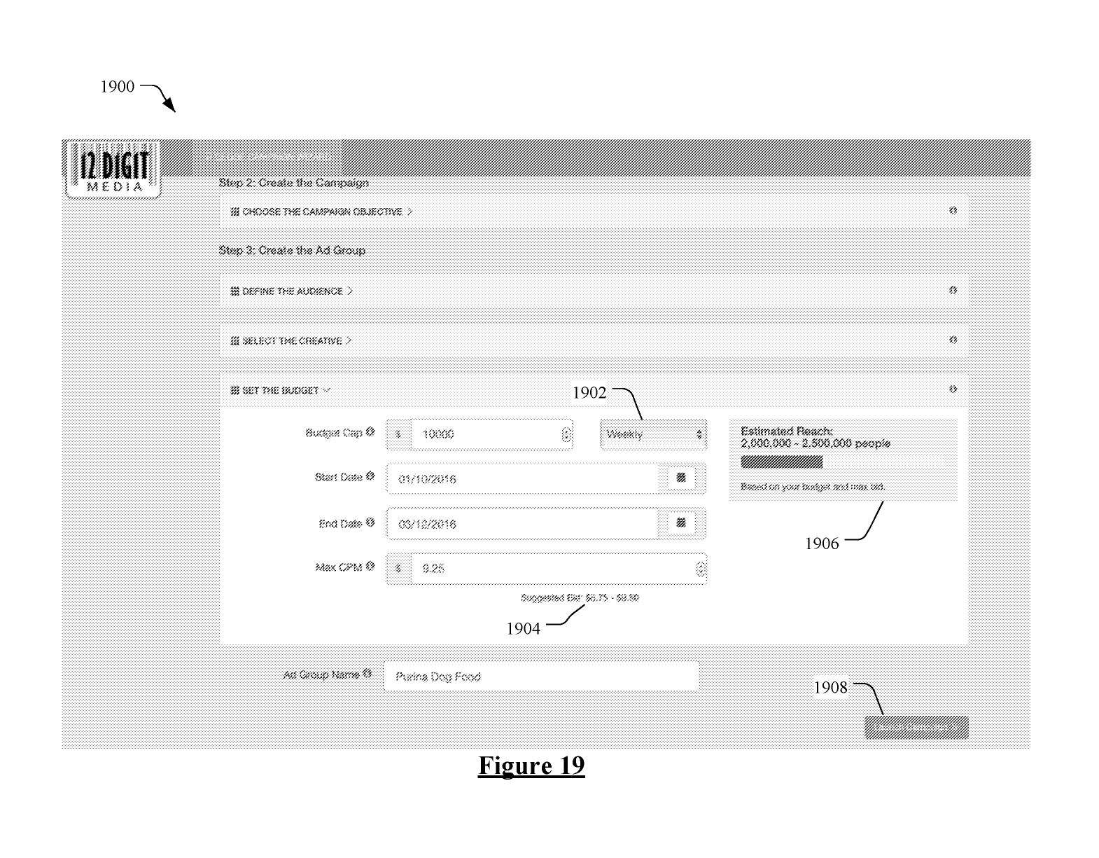

FIG. 19 illustrates an implementation of a campaign wizard of an online exchange for setting a budget and timeframe (e.g., a budget that is valid and/or can be used for an adjustable increment of time) for a specific campaign, according to an embodiment of the present disclosure.

Referring to FIG. 19, a screenshot 1900 of a campaign wizard implemented by an online exchange (e.g., marketplace, online auction, etc.) is illustrated. As illustrated, the user is provided an opportunity to set budget criteria, such as a budget cap, a start date, an end date and a maximum CPM. The budget cap can is the maximum amount the user wants to spend on a campaign. The user can decide, using dropdown menu 1902, a duration (e.g., daily, weekly, monthly, quarterly, yearly, etc.) for which the budget cap applies. For example, the user may set a maximum budget of $10,000 per week, as illustrated in FIG. 19. Additionally, the campaign wizard provides a suggested bid range 1904, using, for example, algorithms that take into account various factors discussed in detail above, such as the UPC or UPCs targeted by the campaign, past bid results, current bidders, etc. While the user sets the budget criteria, the campaign wizard can provide an estimated reach (in terms of people) 1906 based on the set budget and the maximum CPM. Furthermore, the campaign wizard provides the “ad group name,” as discussed with reference to FIG. 16. Once the user has provided all of the necessary information to begin the campaign, as discussed above with reference to FIGS. 16-19, the user can click on a “Launch Campaign” button 1908 to launch the campaign and begin the automated bidding/auction process.

This screenshot 1900 and the information illustrated therein are merely examples and should not be limited by the data and/or options illustrated therein. Additional data and/or options may be provided to the user and/or customized by the user.

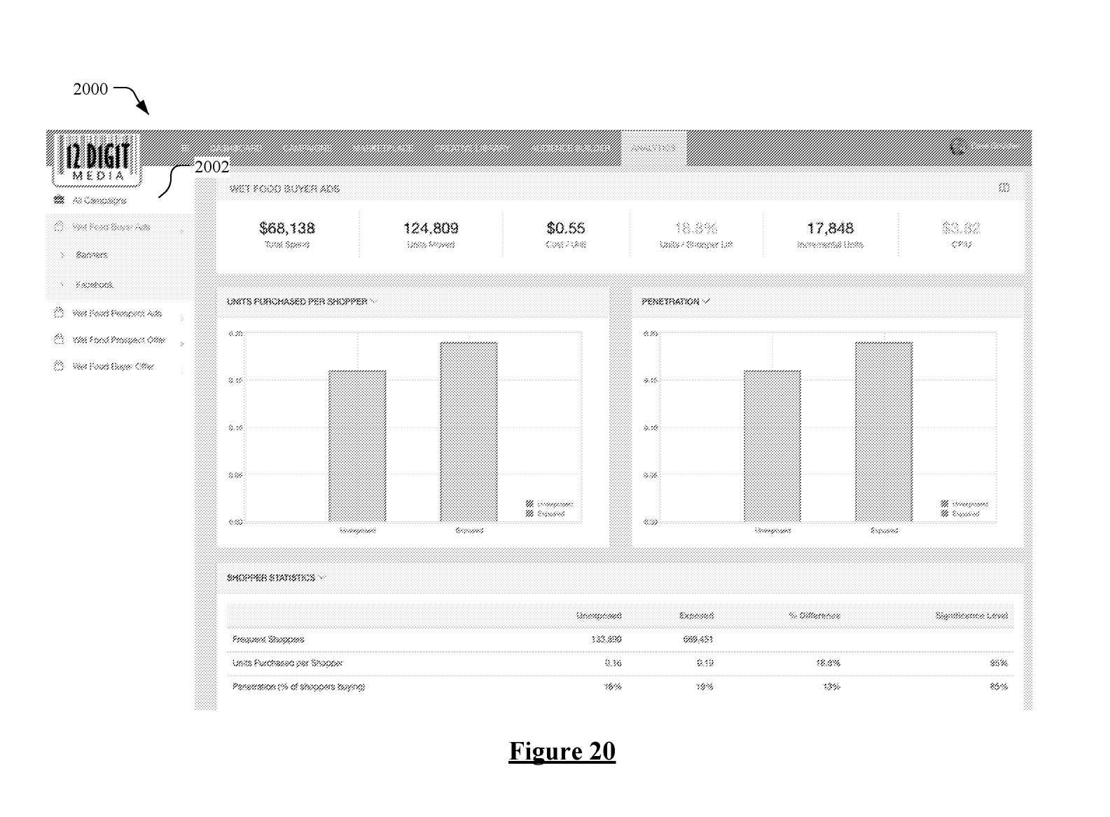

FIG. 20 illustrates a screenshot of an online exchange that provides real-time analytics for a specific campaign, according to an embodiment of the present disclosure.

Referring to FIG. 20, a screenshot 2000 of an analytics interface, as implemented by an online exchange (e.g., marketplace, online auction, etc.) is illustrated. Reference element 2002 identifies a left-hand column that allows a user to select which campaign(s) (e.g., all campaigns, wet food prospect offer, wet food buyer offer, etc.) for which the analytics are provided.

As illustrated in FIG. 20, the user, for example, has selected wet food buyer ads as the campaign for which the analytics are displayed. In this example, the user has spent a total of $68,138 on the campaign and has moved 124,809 units, resulting in an approximate cost per unit (e.g., coupon, ad, etc.) of $0.55. Further, FIG. 20 indicates that there has been an 18.8% shopper lift as a result of the campaign, which translates to 17,848 incremental units. As a result of this example campaign, FIG. 20 illustrates that the user on average has spent $3.82 per unit for the shopper lift.

The analytics can also provide a bar graph illustrating units purchased per shopper for consumers that have been exposed to the campaign and for consumers that have not been exposed to the campaign. Additionally, in an implementation, the analytics can provide a bar graph illustrating the difference in market penetration between consumers that have not been exposed to the campaign and consumers that have been exposed to the campaign.

Moreover, in an implementation, the analytics can provide a table that identifies (i) how many frequent shoppers (e.g., consumers) have been exposed and have not been exposed to the campaign, (ii) units purchased per unexposed shopper (iii) units purchases per exposed shopper, (vi) the percentage difference of units purchased between unexposed and exposed shoppers, (v) a statistical significance level of research confidence based on the level of percentage difference of units purchased per shopper, (vi) a penetration (e.g., percentage of shoppers buying) level for unexposed and exposed shoppers, (vii) and percent difference between the penetration of unexposed and exposed shoppers, and (viii) a statistical significance level of research confidence for the penetration level results.

These analytics are merely examples and additional analytics that are predefined by the online exchange and that are defined by the user may be provided by the online exchange.

FIG. 21 illustrates an interface of an online exchange that provides real-time monitoring and adjustment of a campaign(s), according to an embodiment of the present disclosure.

Referring to FIG. 21, a screenshot 2100 of an interface of an online exchange (e.g., marketplace, online auction, etc.) that provides real-time monitoring and adjustment of a campaign(s) is illustrated. Reference element 2102 identifies a left-hand column that allows a user to select which campaign(s) (e.g., all campaigns, wet food prospect offer, wet food buyer offer, etc.) for which the campaign information is provided.

In FIG. 21, a user has selected to display information regarding “Banners” for “Wet Food Buyer Ads.” In this example, each product of a targeted banner ad is listed in a product column. This same format discussed above and discussed below in further detail also applies when the user is implementing a coupon campaign. As illustrated, for each product (e.g., dog food) a maximum CPM bid (e.g., $12.00) is provided, a number of impressions (e.g., 806,872) is provided, a unique messaged (e.g., 89,652) is provided, an average frequency (e.g., 9.0) is provided, a number of clicks (e.g., 2,945) is provided, a click-through rate (e.g., 0.36%) is provided, a number of conversions (e.g., 16,785) is provided, a conversion rate (e.g., 18.72%) is provided, a cost/unit (e.g., $0.47) is provided, an average CPM (e.g., $10.98) is provided and a spend amount (e.g., $7,867) is provided.

Furthermore, the screenshot 2100 illustrates that the user can select a date range 2104, search for terms 2106, and sort/filter by various criteria 2108.

This screenshot 2100 and the information illustrated therein are merely examples and should not be limited by the data and/or options illustrated therein. Additional data and/or options may be provided to the user and/or customized by the user.

FIG. 22 illustrates an interface of an online exchange that provides real-time information regarding a lift of sales for a retailer, according to an embodiment of the present disclosure.

Referring to FIG. 22, a screenshot 2200 of an interface that provides sales lift information to a user, as implemented by an online exchange (e.g., marketplace), is illustrated. Reference element 2202 identifies a left-hand column that allows a user to select which campaign(s) (e.g., all campaigns, boxed prepared dinners, breakfast meat, etc.) for which the sales lift information is provided.

As illustrated in FIG. 22, the user, for example, has selected to view the sales lift information for all campaigns for the past 30 days. This sales lift information provides a bar graph illustrating sales per shopper for shoppers who are unexposed to the various campaigns and sales per shopper for shoppers who are exposed to the various campaigns. As illustrated in FIG. 22, as a result of all of the user's campaigns, there was a 5.2% sales lift for shoppers exposed to the campaigns, which produced an increase in incremental sales by $174,000,000.

Additionally, this sales lift information provides a bar graph illustrating trips per shopper for shoppers who are unexposed to the various campaigns and trips per shopper for shoppers who are exposed to the various campaigns. As illustrated in FIG. 22, as a result of all of the user's campaigns, there was a 4.3% trip lift (e.g., increase in number of trips per shopper) for shoppers exposed to the campaigns, which produced a total number of increases trips by 4,350,000 for the exposed shoppers.

FIG. 22 also illustrates a summary of shopper value as a result of the campaigns. This summary identifies the number of shoppers who were exposed to the campaigns and the number of shoppers who were not exposed to the campaigns. For the shoppers exposed to the campaigns, the summary indicates an average dollar amount spent per shopper and an average number of trips for each shopper for the past 30 days. Further, for the shoppers who were not exposed to the campaigns, the summary indicates an average dollar amount spent per shopper and an average number of trips for each shopper for the last 30 days.

The analytics can also provide a bar graph illustrating units purchased per shopper for shoppers that have been exposed to the campaign and for shoppers that have not been exposed to the campaign. Additionally, in an implementation, the analytics can provide a bar graph illustrating the difference in market penetration between shoppers that have not been exposed to the campaign and shoppers that have been exposed to the campaign.

This screenshot 2200 and the information illustrated therein are merely examples and should not be limited by the data and/or options illustrated therein. Additional data and/or options may be provided to the user and/or customized by the user.

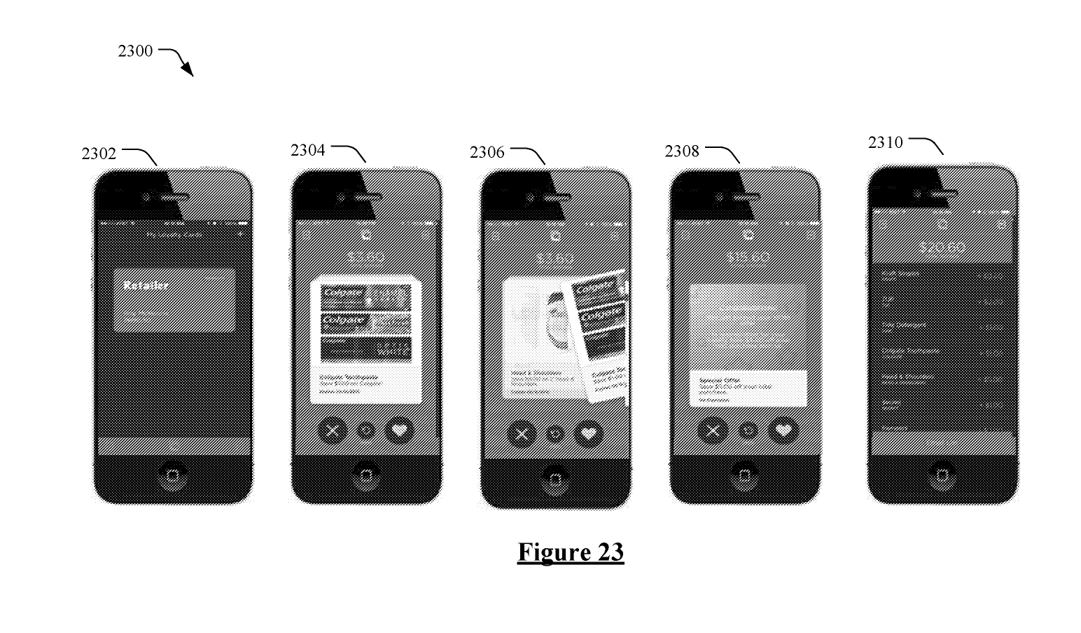

FIG. 23 illustrates screenshots of a consumer application implemented on a smart phone, according to an embodiment of the present disclosure.

Referring to FIG. 23, screenshots 2300 of a consumer application implemented on a smartphone (e.g., the consumer device 622 of FIG. 6) are illustrated.

Referring to reference number 2302, a consumer application running on a consumer device is illustrated, where the consumer has entered their name and loyalty card information. Referring to reference number 2304, while the consumer application is running, the consumer can view various targeted coupons that have been electronically delivered. For example, the consumer has received a targeted coupon for a discount on various Colgate® products. The total discount is displayed as $3.60. The consumer has the ability to delete (e.g., reject) the coupon by selecting the “X” button, identify the coupon as a favorite (e.g., accept the coupon) by selecting the “heart” button and the ability to undo a previous action by selecting the “undo” button.

Referring to reference number 2306, the consumer can also swipe through the various coupons that are available through the consumer application. The consumer may also receive special coupons, such as $5.00 off an entire purchase, as illustrated by reference number 2308. Referring to reference number 2310, once the consumer has viewed and selected all of their desired coupons, the total amount of coupon value is listed (e.g., $20.60) and a shopping list based on the coupons can be created and emailed to the consumer as well.

These screenshots 2300 and the information illustrated therein are merely examples and should not be limited by the data and/or options illustrated therein. Additional data and/or options may be provided to the user and/or customized by the user.

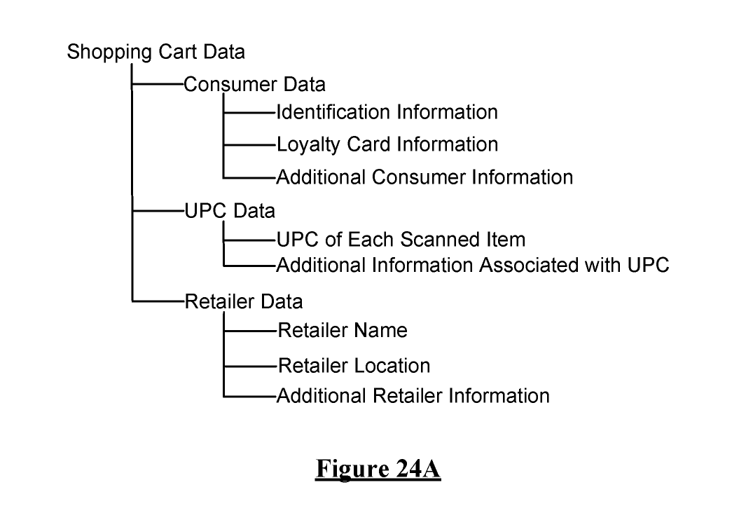

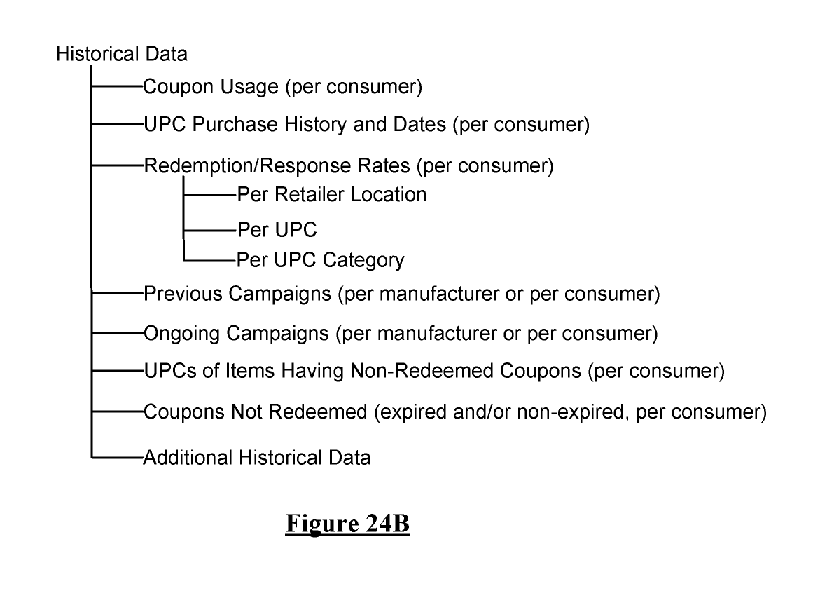

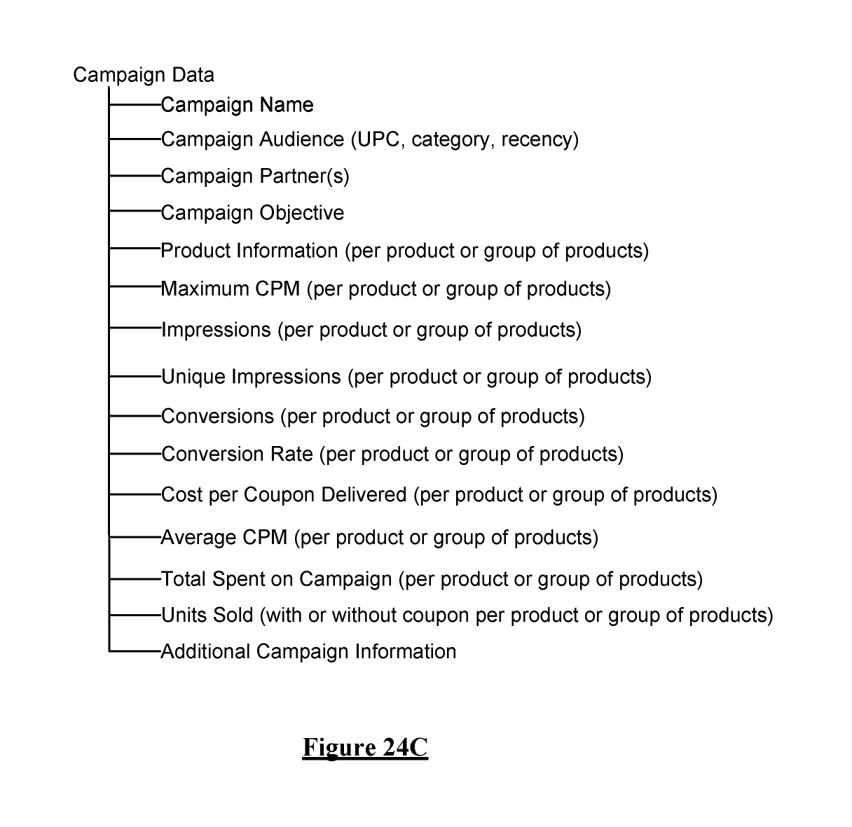

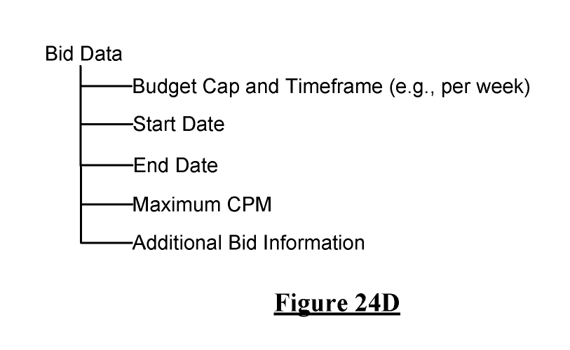

FIGS. 24A-24D illustrate data structures, according to various embodiments of the present disclosure.

Referring to FIG. 24A, a data structure of shopping cart data is illustrated.

Specifically, shopping cart data as discussed above with reference to various figures can include any or all of the following: consumer data; UPC data; and retailer data. Further, the consumer data may include identification information of the consumer, loyalty card information of the consumer, as well as additional consumer information related to the consumer. Additionally, the UPC data may include a UPC of each item scanned by, for example, a POS terminal while the consumer is at the retailer. Also, the UPC data may include additional information that is associated with the scanned UPCs. Moreover, the retailer data may include a retailer name of a retailer selling items that are scanned by the POS terminal (e.g., the retailer name may be identified as Safeway®). The retail data may also include a location (e.g., geographic region, etc.) of the retailer, as well as additional retailer information related to the retailer. In an implementation, this above-described data can be stored in any of the above-described databases, etc., of the system 600 illustrated in FIG. 6. This above-described data structure is not intended to limit the data that can be included in the shopping cart data, but is merely provided as an example implementation of an embodiment of the present disclosure.

Referring to FIG. 24B, a data structure of historical data is illustrated.

Specifically, historical data as discussed above with reference to various figures can include any or all of the following: coupon usage (per consumer); UPC purchase history and dates (per consumer); redemption/response rates (per consumer); previous campaigns (per manufacturer or per consumer); ongoing campaigns (per manufacturer or per consumer) UPCs of items having non-redeemed coupons (per consumer); coupons that have not been redeemed (expired and/or non-expired coupons, per consumer); and additional historical data. Further, the redemption/response rates (per consumer) may identify the rates per retailer location, per UPC and per UPC category. In an implementation, some or all of the above-described historical data can be stored and/or retrieved based on loyalty card information of the consumer. In an implementation, this above-described data can be stored in any of the above-described databases, etc., of the system 600 illustrated in FIG. 6. This above-described data structure is not intended to limit the data that can be included in the historical data, but is merely provided as an example implementation of an embodiment of the present disclosure.

Referring to FIG. 24C, a data structure of campaign data is illustrated.

Specifically, campaign data as discussed above with reference to various figures can include any or all of the following: campaign name; campaign audience based on any or all of UPC, category, recency, etc.; campaign partner(s); campaign objective; product information (per product or group of products; maximum CPM (per product or group of products); impressions (per product or group of products); conversions (per product or group of products); conversion rate (per product or group of products); cost per coupon delivered (per product or group of products); average CPM (per product or group of products); total spent on campaign (per product or group of products); units sold (with or without coupon, per product or group of products); and additional campaign information. A campaign partner is, for example, a retailer (e.g., Safeway®) to which the campaign is directed.

Any or all of this information included in the campaign data can be accumulated on an ongoing basis as a campaign develops and is implemented. For example, the conversions, cost per coupon delivered, average CPM, total spent, etc., will change over time based on the success of the campaign. Additionally, the user (e.g., the manufacturer) may change the maximum CPM, the campaign partners, etc., during the implementation of the campaign. This above-described campaign data is described in detail with reference to FIGS. 16-21 and redundant descriptions thereof are omitted. In an implementation, this above-described data can be stored in any of the above-described databases, etc., of the system 600 illustrated in FIG. 6. This above-described data structure is not intended to limit the data that can be included in the campaign data, but is merely provided as an example implementation of an embodiment of the present disclosure.

Referring to FIG. 24D, a data structure of bid data is illustrated.

Specifically, bid data as discussed above with reference to various figures can include any or all of the following: budget cap and timeframe (e.g., per week); start date; end date; maximum CPM; and additional bid information. This above-described bid data is described in detail with reference to FIGS. 16-21 and redundant descriptions thereof are omitted. In an implementation, this above-described data can be stored in any of the above-described databases, etc., of the system 600 illustrated in FIG. 6. This above-described data structure is not intended to limit the data that can be included in the bid data, but is merely provided as an example implementation of an embodiment of the present disclosure.

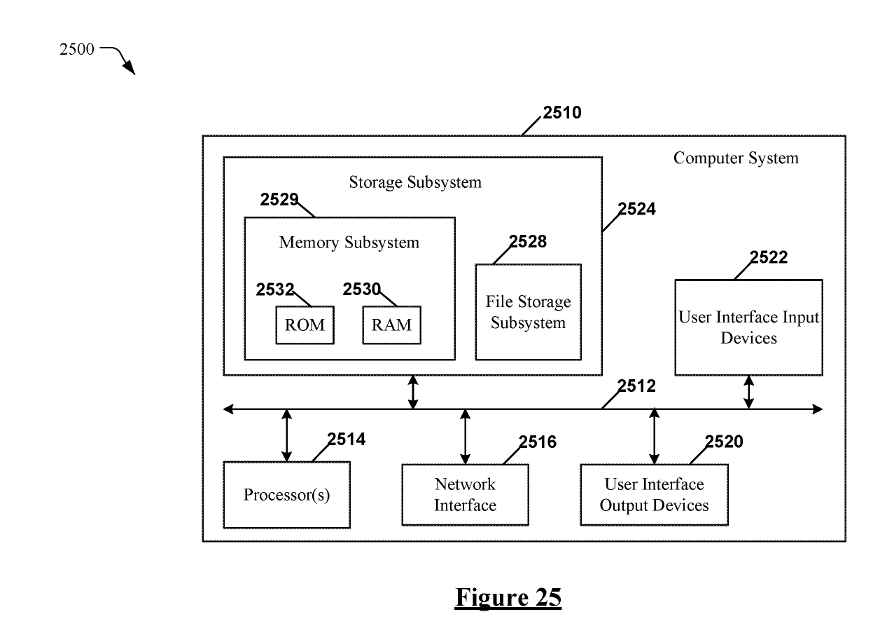

FIG. 25 is a block diagram of an example computer system, according an embodiment of the present disclosure.

Referring to FIG. 25, a block diagram 2500 representing an example computer system 2510 (e.g., laptop, desktop, tablet, smart phone, smart watch, etc.) is illustrated. This computer system 2510, or portions thereof, can be implemented as any or all of the components of the system 600 illustrated in FIG. 6, including, for example, the marketing computer 604, the server 630, the retail server 608, the consumer device 622, the campaign engine 602, the UPC library database 632, the user profile database 634, the marketplace management server 636, the bidding engine 638, the coupon distribution engine 640, the coupon clearance engine 642, the media delivery server 644, the coupon/UPC history database 646, the campaign data server/database 648, the consumer device 622, etc. Further, the computer system 2510, or portions thereof, may be implemented as a handheld smart device, such as a smartphone, tablet, etc. Additionally, the system 600 may not be limited to the use of a single computer system 2510, such that the system 600 may implement an unlimited number of computer systems 2510.

The computer system 2510 includes at least one processor 2514 that communicates with a number of peripheral devices via bus subsystem 2512. These peripheral devices can include a storage subsystem 2524 including, for example, a memory subsystem 2529 and a file storage subsystem 2528, user interface input devices 2522, user interface output devices 2520, and a network interface 2516.

The user interface input devices 2522 and the user interface output devices 2520 allow user interaction with the computer system 2510. The network interface 2516 provides an interface to outside networks, including an interface to corresponding interface devices in other computer systems.

The user interface input devices 2522 can include, for example, a keyboard, pointing devices such as a mouse, trackball, touchpad, or graphics tablet, a scanner, a touch screen incorporated into a display, audio input devices such as voice recognition systems and microphones, and other types of input devices. In general, use of the term “input device” is intended to include all possible types of devices and ways to input information into the computer system 2510.

The user interface output devices 2520 can include, for example, a display subsystem, a printer, a fax machine, and non-visual displays such as audio output devices. The display subsystem (not illustrated) can include a cathode ray tube (CRT), a flat-panel device such as a liquid crystal display (LCD), a projection device, and/or some other mechanism for creating a visible image. The display subsystem can also provide a non-visual display such as audio output devices. In general, use of the term “output device” is intended to include all possible types of devices and ways to output information from the computer system 2510 to the user or to another machine or computer system.

The storage subsystem 2524 stores programming and data constructs that provide the functionality of some or all of the modules and methods described herein. These software modules are generally executed by the processor(s) 2514 alone or in combination with other processors.

The memory subsystem 2529 of the storage subsystem 2524 can include a number of memories including a main random access memory (RAM) 2530 for storage of instructions and data during program execution and a read only memory (ROM) 2532 in which fixed instructions are stored.

The file storage subsystem 2528 can provide persistent storage for program and data files, and can include a hard disk drive, a floppy disk drive along with associated removable media, a CD-ROM drive, an optical drive, or removable media cartridges. The modules implementing the functionality of certain implementations can be stored by the file storage subsystem 2528 of the storage subsystem 2524, or in other machines accessible by the processor(s) 2514.

The bus subsystem 2512 provides a mechanism for letting the various components and subsystems of the computer system 2510 communicate with each other as intended. Although the bus subsystem 2512 is shown schematically as a single bus, alternative implementations of the bus subsystem 2512 according to an embodiment of the present disclosure can use multiple busses.

The computer system 2510 can be of varying types including a workstation, a server, a computing cluster, a blade server, a server farm, or any other data processing system or computing device. Due to the ever-changing nature of computers and networks, the description of the computer system 2510 illustrated in FIG. 25 is intended only as one example. Many other configurations of the computer system 2510 are possible having more or fewer components than the computer system 2510 illustrated in FIG. 25.

Other implementations of the present disclosure may include a non-transitory computer-readable recording medium having a program recorded thereon, the program causing a computer including at least one of a processor and a memory to perform/execute any of the methods, operations and/or functions described above. Yet another implementation may include a system including memory and one or more processors operable to execute instructions, stored in the memory, to perform any of the methods, operations and/or functions described above. While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A computer-implemented method of providing one or more targeted coupons to a consumer, the method including:
collecting shopping cart data from numerous point of sale (POS) terminals in physical stores, the shopping cart data identifying a consumer using a unique consumer identification and identifying one or more universal product codes (UPCs) scanned while the identified consumer is present at one of the POS terminals;
conducting an online UPC auction to collect bids, by UPC or a group of UPCs, for delivery of coupons to the identified consumer triggered by scanning of a UPC or UPCs in the physical stores, in which winning bids, if any, are determined as of the time the identified consumer is present at the POS terminal, wherein:
a current winning bidder for a particular UPC is entitled to send their coupon to the POS terminal for printing, to send a message to the POS terminal for printing that refers to an electronic coupon delivery, and/or send an electronic coupon to the identified consumer; and
the online UPC auction accepts bids and withdrawal of bids from bidding participants using bidding terminals, and determines the current winning bidder from among the bidding participants on an ongoing basis by:
providing a bidding interface to the bidding terminals that identifies the UPCs that are available through the online UPC auction;
receiving from the bidding interface, bids on selected UPCs of the available UPCs;
tracking, for the selected UPCs, bid scores based at least in part on the bids on the selected UPCs; and
while the identified consumer remains present at the POS terminal, using at least the bid scores to determine a current best bid for a particular UPC and determining, among the one or more UPCs identified by the shopping cart data, which UPCs have winning bidders; and
on behalf of a winning bidder, fulfilling the winning bidder's bid by, at least one of, sending the coupon to the POS terminal for printing, sending the message to the POS terminal for printing, and sending the electronic coupon to the identified consumer.

2. The computer-implemented method of claim 1, wherein the fulfilling of the winner bidder's bid is performed in response to an election by the winning bidder to fulfill the winning bidder's bid, and wherein the winning bidder is provided an option to elect to not send the coupon, to not send the message and to not send the electronic coupon.

3. The computer-implemented method of claim 1, wherein the receiving from the bidding interface further includes receiving bid effective dates and coupon descriptions that include coupon values.

4. The computer-implemented method of claim 1, wherein at least one of the identified one or more UPCs is identified using a stock keeping unit code (SKU).

5. The computer-implemented method of claim 1, wherein the received bids are for delivering the coupon during a time frame starting from a certain start date and ending at a certain end date.

6. The computer-implemented method of claim 5, wherein the received bids are for delivering the coupon to a specified number of consumers during the time frame.

7. The computer-implemented method of claim 1, wherein the received bids are for delivering the coupon within a particular geographic region.

8. The computer-implemented method of claim 1, wherein each of the bid scores is determined according to at least one of:
a cost per mille (CPM) bid received by each of the bidding participants;
a predicted experiential conversion rate of each of the bidding participants;
an actual experiential conversion rate of each of the bidding participants;
a combination of the CPM bid and the predicted or actual experiential conversion rate for each of the bidding participants;
a value of the coupon set by each of the bidding participants; and
a prior targeted coupon conversion rate of each of the bidding participants.

9. The computer-implemented method of claim 1, further comprising:
setting, by the winning bidder, criteria according to which the coupon must be sent to the identified consumer; and
sending the coupon to the identified consumer only when the identified consumer satisfies the criteria set by the winning bidder.

10. The computer-implemented method of claim 9, wherein the criteria includes at least one of:
recent purchases of the identified consumer;
dollar amount of the recent purchases of the identified consumer;
prior coupon redemption rates of the identified consumer; and
an ending date for which the coupon can be delivered to the identified consumer.

11. The computer-implemented method of claim 1, wherein the bidding interface provides an online user interface for creating a campaign that is:
targeted to a specific retailer partner; and
based on an objective selected from a group of objectives including grow a category, increase loyalty, launch a new product or product line, convert in-market shoppers and generate demand for a brand.

12. The computer-implemented method of claim 11, wherein the online user interface provides for targeting specific consumers based on UPC data by, at least one of:
defining an audience of consumers at a UPC granular level;
by selecting a pre-defined audience;
selecting a recency of a purchase or purchases of consumers; and
defining a budget for a specific and adjustable increment of time.

13. The computer-implemented method of claim 1, wherein:
the electronic coupon is sent to a mobile device application for use by identified consumer;
the mobile device application includes an interface allowing the identified consumer to accept or reject received coupons;
the rejected coupons are deleted;
the accepted coupons are stored in a list; and
the accepted coupons can be redeemed by the identified consumer using a single scan at a POS terminal.

14. The computer-implemented method of claim 1, wherein the electronic coupon is sent to a mobile device application for use by the identified consumer on behalf of the winning bidder.

15. The computer-implemented method of claim 1, wherein only a predetermined maximum number of winning bidders is determined as of the time the identified consumer is present at the POS terminal, such that the identified consumer is eligible to receive, at most, a certain number of coupons and/or messages as a result of the UPCs identified by their shopping cart data.

16. The computer-implemented method of claim 1, wherein a notification is sent to the winning bidder and in response to the notification the winning bidder is provided options regarding delivery of the coupon, the message and the electronic coupon.

17. A non-transitory computer-readable recording medium having a program recorded thereon, the program for providing one or more targeted coupons to a consumer, and the program causing a computer comprising at least one of a processor and a memory to execute the computer-implemented method of claim 1.

18. A computer-implemented method of providing one or more targeted coupons to a consumer, the method including:
collecting one or more universal product codes (UPCs) scanned while a consumer is present at one point of sale (POS) terminal of numerous POS terminals in physical stores;
conducting an online UPC auction to collect bids, by UPC or a group of UPCs, for delivery of coupons to the consumer triggered by scanning of a UPC or UPCs in the physical stores, in which winning bids, if any, are determined as of the time the consumer is present at the POS terminal, wherein:
a current winning bidder for a particular UPC is entitled to send their coupon to the POS terminal for printing; and
the online UPC auction accepts bids and withdrawal of bids from bidding participants using bidding terminals, and determines the current winning bidder from among the bidding participants on an ongoing basis by:
providing a bidding interface to the bidding terminals that identifies the UPCs that are available through the online UPC auction;
receiving from the bidding interface, bids on selected UPCs of the available UPCs;
tracking, for the selected UPCs, bid scores based at least in part on the bids on the selected UPCs; and
while the consumer remains present at the POS terminal, using at least the bid scores to determine a current best bid for a particular UPC and determining, among the one or more collected UPCs, which UPCs have winning bidders; and
on behalf of a winning bidder, fulfilling the winning bidder's bid by sending the coupon to the POS terminal for printing.

19. The computer-implemented method of claim 18, wherein the fulfilling of the winner bidder's bid is performed in response to an election by the winning bidder to fulfill the winning bidder's bid, and wherein the winning bidder is provided an option to elect to not send the coupon, to not send the message and to not send the electronic coupon.

20. The computer-implemented method of claim 18, wherein the receiving from the bidding interface further includes receiving bid effective dates and coupon descriptions that include coupon values.

21. The computer-implemented method of claim 18, wherein the received bids are for delivering the coupon during a time frame starting from a certain start date and ending at a certain end date.

22. The computer-implemented method of claim 18, wherein the received bids are for delivering the coupon within a particular geographic region.

23. The computer-implemented method of claim 18, wherein each of the bid scores is determined according to at least one of:
a cost per mille (CPM) bid received by each of the bidding participants;
a predicted experiential conversion rate of each of the bidding participants;
an actual experiential conversion rate of each of the bidding participants;
a combination of the CPM bid and the predicted or actual experiential conversion rate for each of the bidding participants;
a value of the coupon set by each of the bidding participants; and
a prior targeted coupon conversion rate of each of the bidding participants.

24. The computer-implemented method of claim 18, wherein the bidding interface provides an online user interface for creating a campaign that is:
targeted to a specific retailer partner; and
based on an objective selected from a group of objectives including grow a category, increase loyalty, launch a new product or product line, convert in-market shoppers and generate demand for a brand.

25. The computer-implemented method of claim 18, wherein only a predetermined maximum number of winning bidders is determined as of the time the consumer is present at the POS terminal, such that the consumer is eligible to receive, at most, a certain number of coupons as a result of the collected UPCs.

26. A non-transitory computer-readable recording medium having a program recorded thereon, the program for providing one or more targeted coupons to a consumer, and the program causing a computer comprising at least one of a processor and a memory to execute the computer-implemented method of claim 18.

27. A computer-implemented method of providing one or more targeted coupons to a consumer, the method including:
accumulating, as historical data, shopping cart data from numerous point of sale (POS) terminals in physical stores, the shopping cart data identifying a consumer using a unique consumer identification and identifying one or more universal product codes (UPCs) scanned while the identified consumer is present at one of the POS terminals;
conducting an online UPC auction to collect bids, by UPC or a group of UPCs, for delivery of coupons to the identified consumer triggered by identification of the consumer at the POS terminal, in combination with the historical data that identifies UPCs of goods purchased by the identified consumer in the physical stores, in which winning bids, if any, are determined as of the time the identified consumer is present at the POS terminal, wherein:
the online UPC auction is conducted using the one or more UPCs identified by the historical data collected in a historical period of at least one week and associated with the unique consumer identification of the identified consumer;
a current winning bidder for a particular UPC is entitled to send their coupon to the POS terminal for printing, to send a message to the POS terminal for printing that refers to an electronic coupon delivery, and/or send an electronic coupon to the identified consumer; and
the online UPC auction accepts bids and withdrawal of bids from bidding participants using bidding terminals, and determines the current winning bidder from among the bidding participants on an ongoing basis by:
receiving from a bidding interface, bids on selected UPCs of UPCs that are available UPCs through the online UPC auction, the selected UPCs being included in the historical data;
tracking, for the selected UPCs, bid scores based at least in part on the bids on the selected UPCs; and
while the identified consumer remains present at the POS terminal, using at least the bid scores to determine a current best bid for a particular UPC and determining, among the one or more UPCs identified by the historical data, which UPCs have winning bidders; and
on behalf of a winning bidder, fulfilling the winning bidder's bid by, at least one of, sending the coupon to the POS terminal for printing, sending the message to the POS terminal for printing, and sending the electronic coupon to the identified consumer.

28. The computer-implemented method of claim 27, wherein the fulfilling of the winner bidder's bid is performed in response to an election by the winning bidder to fulfill the winning bidder's bid, and wherein the winning bidder is provided an option to elect to not send the coupon, to not send the message and to not send the electronic coupon.

29. The computer-implemented method of claim 27, wherein the receiving from the bidding interface further includes receiving bid effective dates and coupon descriptions that include coupon values.

30. The computer-implemented method of claim 27, wherein the bid scores are determined using historical purchase information and historical coupon redemption information associated with the identified consumer, the computer-implemented method further comprising:
setting, by the winning bidder, criteria according to which the coupon must be sent to the identified consumer; and
sending the coupon to the identified consumer only when the identified consumer satisfies the criteria set by the winning bidder.

31. The computer-implemented method of claim 27, further comprising:
setting, by the winning bidder, criteria according to which the coupon must be sent to the identified consumer; and
sending the coupon to the identified consumer only when the identified consumer satisfies the criteria set by the winning bidder,
wherein the criteria includes at least one of:
recent purchases of the identified consumer;
dollar amount of the recent purchases of the identified consumer;
prior coupon redemption rates of the identified consumer; and
an ending date for which the coupon can be delivered to the identified consumer.

32. A non-transitory computer-readable recording medium having a program recorded thereon, the program for providing one or more targeted coupons to a consumer, and the program causing a computer comprising at least one of a processor and a memory to execute the computer-implemented method of claim 27.

33. A computer-implemented method of providing one or more targeted coupons to a consumer, the method including:
collecting shopping cart data from numerous point of sale (POS) terminals in physical stores, the shopping cart data identifying a consumer using a unique consumer identification and identifying one or more remnant universal product codes (UPCs) scanned while the identified consumer is present at one of the POS terminals;
conducting an online UPC auction to collect bids, by UPC or a group of UPCs, for delivery of coupons to the identified consumer triggered by scanning of a remnant UPC or remnant UPCs in the physical stores, in which winning bids, if any, are determined as of the time the identified consumer is present at the POS terminal, wherein:
the remnant UPC or the remnant UPCs are a portion of available UPCs that have not been exclusively sold through a pre-auction channel;
a current winning bidder for a particular remnant UPC is entitled to send their coupon to the POS terminal for printing, to send a message to the POS terminal for printing that refers to an electronic coupon delivery, and/or send an electronic coupon to the identified consumer; and
the online UPC auction accepts bids and withdrawal of bids from bidding participants using bidding terminals, and determines the current winning bidder from among the bidding participants on an ongoing basis by:
providing a bidding interface to the bidding terminals that identifies the remnant UPCs that are available through the online UPC auction;
receiving from the bidding interface, bids on selected remnant UPCs of the available remnant UPCs;
tracking, for the selected remnant UPCs, bid scores based at least in part on the bids on the selected remnant UPCs; and
while the identified consumer remains present at the POS terminal, using at least the bid scores to determine a current best bid for a particular remnant UPC and determining, among the one or more remnant UPCs identified by the shopping cart data, which remnant UPCs have winning bidders; and
on behalf of a winning bidder, fulfilling the winning bidder's bid by, at least one of, sending the coupon to the POS terminal for printing, sending the message to the POS terminal for printing, and sending the electronic coupon to the identified consumer.

34. The computer-implemented method of claim 33, wherein the fulfilling of the winner bidder's bid is performed in response to an election by the winning bidder to fulfill the winning bidder's bid, and wherein the winning bidder is provided an option to elect to not send the coupon, to not send the message and to not send the electronic coupon.

35. The computer-implemented method of claim 33, wherein the receiving from the bidding interface further includes receiving bid effective dates and coupon descriptions that include coupon values.

36. A non-transitory computer-readable recording medium having a program recorded thereon, the program for providing one or more targeted coupons to a consumer, and the program causing a computer comprising at least one of a processor and a memory to execute the computer-implemented method of claim 33.

37. A system for providing one or more targeted coupons to a consumer, the system comprising:
a bidding server including a processor and memory configured to:
receive shopping cart data collected from numerous point of sale (POS) terminals in physical stores, the shopping cart data identifying a consumer using a unique consumer identification and identifying one or more universal product codes (UPCs) scanned while the identified consumer is present at one of the POS terminals; and
conduct an online UPC auction to collect bids, by UPC or a group of UPCs, for delivery of coupons to the identified consumer triggered by scanning of a UPC or UPCs in the physical stores, in which winning bids, if any, are determined as of the time the identified consumer is present at the POS terminal, wherein:
a current winning bidder for a particular UPC is entitled to, via a fulfillment server, send their coupon to the POS terminal for printing, to send a message to the POS terminal for printing that refers to an electronic coupon delivery, and/or send an electronic coupon to the identified consumer; and
the bidding server, by conducting the online UPC auction, accepts bids and withdrawal of bids from bidding participants using bidding terminals, and determines the current winning bidder from among the bidding participants on an ongoing basis by:
providing a bidding interface to the bidding terminals that identifies the UPCs that are available through the online UPC auction;
receiving from the bidding interface, bids on selected UPCs of the available UPCs;
tracking, for the selected UPCs, bid scores based at least in part on the bids on the selected UPCs; and
while the identified consumer remains present at the POS terminal, using at least the bid scores to determine a current best bid for a particular UPC and determining, among the one or more UPCs identified by the shopping cart data, which UPCs have winning bidders; and
the fulfillment server including a processor and a memory configured to, on behalf of a winning bidder determined by the bidding server, fulfilling the winning bidder's bid by, at least one of, sending the coupon to the POS terminal for printing, sending the message to the POS terminal for printing, and sending the electronic coupon to the identified consumer.

38. The system of claim 37, wherein the fulfilling of the winner bidder's bid, as performed by the fulfillment server, is performed in response to an election by the winning bidder to fulfill the winning bidder's bid, and wherein the winning bidder is provided an option to elect to not send the coupon, to not send the message and to not send the electronic coupon.

39. The system of claim 37, wherein the receiving from the bidding interface, as performed by the bidding server, further includes receiving bid effective dates and coupon descriptions that include coupon values.
